(19) United States
(12) Patent Application Publication
(10) Pub. No.: US 2018/0144427 A1
(43) Pub. Date: May 24, 2018

(54) WORKER DATA DETECTION SYSTEM, TERMINAL DEVICE, AND WORKER DATA DETECTION METHOD

(71) Applicant: Takafumi EBESU, Kanagawa (JP)

(72) Inventor: Takafumi EBESU, Kanagawa (JP)

(21) Appl. No.: 15/795,558

(22) Filed: Oct. 27, 2017

(30) Foreign Application Priority Data
Nov. 22, 2016 (JP) 2016-226907

(51) Int. Cl. G06Q 50/26; G08B 21/04; G08B 25/14; G06Q 10/06

(52) U.S. Cl. CPC G06Q 50/265; G06Q 10/063114; G08B 25/14; G08B 21/0446

(57) ABSTRACT

A worker data detection system, a terminal device, and a method for detecting worker data. The worker data detection system and the terminal device include a memory and circuitry. The circuitry obtains data of at least one worker, extracts load data of the worker from the data of the worker to accumulate the load data of the worker over time in the memory, and calculates a cumulative load on the worker over time using the load data accumulated in the memory. The method for detecting worker data includes obtaining data of at least one worker, extracting load data of the worker from the data of the worker to accumulate the load data of the worker over time, and calculating a cumulative load on the worker over time using the load data.

### CROSS-REFERENCE TO RELATED APPLICATION

This patent application is based on and claims priority pursuant to 35 U.S.C. § 119(a) to Japanese Patent Application No. 2016-226907, filed on Nov. 22, 2016, in the Japan Patent Office, the entire disclosure of which is hereby incorporated by reference herein.

### BACKGROUND

### Technical Field

Embodiments of the present disclosure relate to a worker data detection system, a terminal device, and a worker data detection method.

### Background Art

Some cooperation support systems are known that support a human and a computer in working together. It is expected that making use of such a cooperation support system would improve the efficiency or safety of workers who work in a shop floor such as a warehouse and a factory. More specifically, it is expected that making use of such a cooperation support system would enable, for example, an improvement in work load, the management of operation process, changes in location of parts or the like, and detection of an error in operation and avoidance of its repetition.

### SUMMARY

Embodiments of the present disclosure described herein provide a worker data detection system, a terminal device, and a method for detecting worker data. The worker data detection system and the terminal device includes a memory and circuitry. The circuitry obtains data of at least one worker, extracts load data of the at least one worker from the data of the at least one worker to accumulate the load data of the at least one worker over time in the memory, and calculates a cumulative load on the at least one worker over time using the load data accumulated in the memory. The method for detecting worker data includes obtaining data of at least one worker, extracting load data of the at least one worker from the data of the at least one worker to accumulate the load data of the at least one worker over time, and calculating a cumulative load on the at least one worker over time using the load data.

### BRIEF DESCRIPTION OF THE DRAWINGS

A more complete appreciation of exemplary embodiments and the many attendant advantages thereof will be readily obtained as the same becomes better understood by reference to the following detailed description when considered in connection with the accompanying drawings.

FIG. 1 is a schematic diagram illustrating processes of a worker data detection system, according to an embodiment of the present disclosure.

FIG. 2 is a diagram illustrating a schematic configuration of a worker data detection system according to an embodiment of the present disclosure.

FIG. 3 is a schematic block diagram illustrating a hardware configuration of a terminal device, according to an embodiment of the present disclosure.

FIG. 4 is a schematic block diagram illustrating a hardware configuration of a monitoring apparatus, according to an embodiment of the present disclosure.

FIG. 5 is a functional block diagram of a terminal device, a monitoring apparatus, and an administrator's PC, according to an embodiment of the present disclosure.

FIG. 6A is a diagram illustrating recognition of bowing or bending backward posture, according to an embodiment of the present disclosure.

FIG. 6B is a diagram illustrating recognition of squat posture, according to an embodiment of the present disclosure.

FIG. 7 is a flowchart of procedure for determining a threshold by a parameter adjuster, according to an embodiment of the present disclosure.

FIG. 8 is a flowchart of procedure for temporarily changing a threshold depending on the working environment, by a parameter adjuster, according to an embodiment of the present disclosure.

FIG. 9 is a flowchart of procedure for determining an initial value of cumulative load by a parameter adjuster, according to an embodiment of the present disclosure.

FIG. 10 is a flowchart of procedure for calculating load in view of the working environment by a work-load computation unit, according to an embodiment of the present disclosure.

FIG. 11 is a diagram illustrating the relation among a first threshold, a second threshold, and a third threshold, according to an embodiment of the present disclosure.

FIG. 12 is a data sequence diagram illustrating overall operation of a worker data detection system, according to an embodiment of the present disclosure.

FIG. 13 is a flowchart of procedure for calculating the cumulative load to give warning, by a monitoring apparatus, according to an embodiment of the present disclosure.

FIG. 14A is a diagram depicting a warning displayed on an administrator's PC, according to an embodiment of the present disclosure.

FIG. 14B is a diagram illustrating a personal load screen provided by a web server unit, according to an embodiment of the present disclosure.

FIG. 15 is a diagram illustrating a comparison screen on which the cumulative loads of a plurality of workers in a day are tabulated for comparison, according to an embodiment of the present disclosure.

FIG. 16A and FIG. 16B are diagrams illustrating an example in which moving distances that vary depending on the location of parts are compared with each other.

FIG. 17 is a diagram illustrating a map screen where the relation between a map of a shop floor and cumulative loads is illustrated, according to an embodiment of the present disclosure.

FIG. 18 is another data sequence diagram illustrating overall operation of a worker data detection system, according to an embodiment of the present disclosure.

FIG. 19 is another flowchart of procedure for calculating the cumulative load to give warning, by a monitoring apparatus, according to an embodiment of the present disclosure.

FIG. 20 is a functional block diagram of a terminal device that judges a posture and sends a warning, according to an embodiment of the present disclosure.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

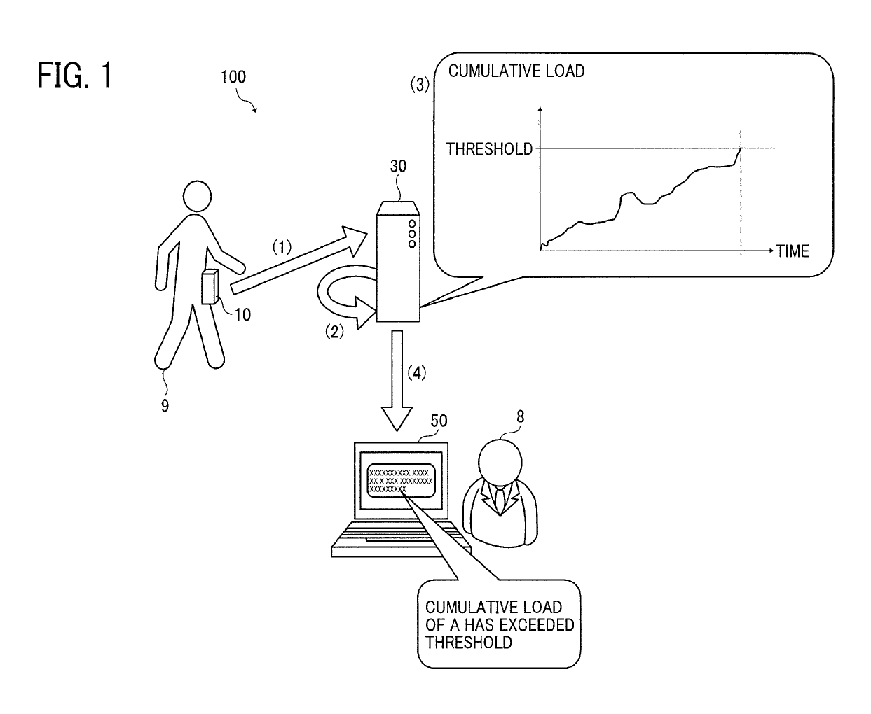

Hereinafter, a worker data detection system 100 and a worker data detection method performed by the worker data detection system 100 according to an embodiment of the present disclosure are described with reference to the accompanying drawings. FIG. 1 is a schematic diagram illustrating processes of the worker data detection system 100, according to the present embodiment. A worker 9 wears a terminal device 10 on his/her body, and he/she carries the terminal device 10 at least during his/her work.

(1) The terminal device 10 continuously detects information about the work of the worker 9, and sends such information about the work of the worker 9 to a monitoring apparatus 30 in real time. Note also that such information about the work of the worker 9 will be referred to as worker data in the following description.

(2) The monitoring apparatus 30 analyzes the worker data to determine whether the worker 9 has adopted predetermined posture or done predetermined operation, and when the worker 9 has adopted such predetermined posture, the monitoring apparatus 30 converts the posture into load.

(3) Then, the monitoring apparatus 30 accumulates the load with respect to time. Basically, the load increases over the course of time. However, for example, when a rest is taken, the load may decrease.

(4) When the cumulative load exceeds a threshold, the monitoring apparatus 30 determines that the worker 9 is in an alerted state, and an alert is sent to at least one of the terminal device 10 and the administrator 8. In FIG. 1, the administrator 8 is notified of such an alert. The administrator 8 monitors an administrator's personal computer (PC) 50 to check which worker 9's cumulative load has exceeded the threshold, and tries to improve the working environment. In particular, the administrator 8 lets the worker 9 to have a rest, or changes the layout of the working environment.

As described above, with the worker data detection system 100 according to the present embodiment that accumulates the worker data, for example, the cumulative load that has been accumulated since the worker 9 started working can be managed. When the cumulative load exceeds the threshold, the working environment of the worker 9 is improved before an accident happens or the worker 9 actually complains of a bad condition. Accordingly, accidents can be prevented from happening.

The term “work” generally indicates physical labor or brainwork, but in the present disclosure, mainly refers to the physical labor, and

The term “worker” indicates a subject who does the work.

The term “worker data” indicates the information about the work that can be obtained from the worker. Note also that the worker data includes the load data that indicates the load on the worker. The term “load” indicates physical load or the intensity of the load. The term “load data” indicates, for example, the volume, level, or degree of the load, or the data that can be converted into such a volume, level, or degree of load.

The term “alerted state” indicates a state in which fatigue is predicted to build in the body of a worker. In particular, an alerted state indicates a state when the cumulative load exceeds a threshold.

The term “posture” indicates the way the worker positions his/her body. More specifically, the term “posture” indicates, for example, the position, twist, movement, orientation, and inclination that are caused by a combination of various kinds of joint movement in a body, or variations that occur accordingly.

<System Configuration>

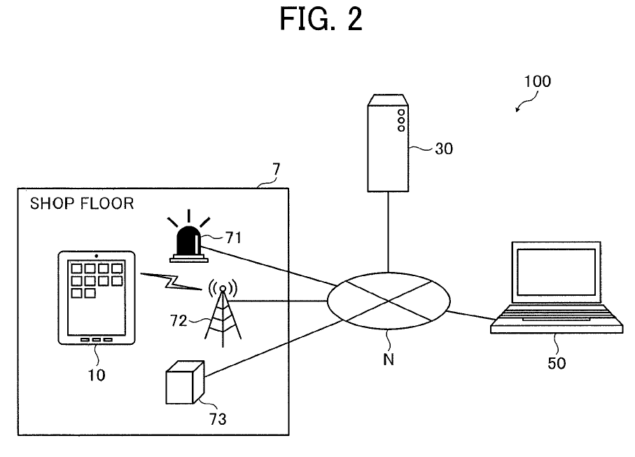

FIG. 2 is a diagram illustrating a schematic configuration of a worker data detection system 100 according to an embodiment of the present disclosure.

The worker data detection system 100 includes a terminal device 10 that the worker 9 carries, a beacon transmitter 73, a warning light 71, a monitoring apparatus 30, and the administrator's PC 50, and these devices are connected to a network N. The terminal device 10 can communicate with the monitoring apparatus 30, and the monitoring apparatus 30 can communicate with the administrator's PC 50 and the warning light 71. Note also that the worker 9 does his/her work on the shop floor 7.

The network N is mainly a local area network (LAN) that is built on the shop floor 7. However, in addition to such a LAN, the network N may be built, for example, by the network of a provider that connects the LAN to the Internet, and the line or circuit provided by a carrier. When the network includes a plurality of LANs, the network is referred to as a wide area network (WAN) or the Internet. The network may be configured through either a wired or wireless connection, and the wired connection and the wireless connection may be combined. When the network N is configured through a wireless connection, an access point 72 that is connected to the network through a wired connection is involved in most cases. The access point 72 is a radio communication device that connects the client of a wired connection to a wired LAN.

When the terminal device 10 is provided with a circuit switching communication device such as of third generation (3G) and long term evolution (LTE), the terminal device 10 can connect to the Internet through the circuit of a carrier. Note that the Internet is an international computer network that connects other networks and computers all over the world.

A shop floor 7 is an area where the worker 9 does his/her work. In particular, the shop floor 7 includes various kinds of places such as a warehouse (logistics warehouse), a factory, a construction site, a day-care center for elderly people, a home, and other outdoor workplaces (such as a forest, guard, and delivery). In the present embodiment, cases of a warehouse are described for the sake of explanatory convenience.

The warning light 71 and the beacon transmitter 73 are arranged in the shop floor 7. The warning light 71 is an attention attracting device for people around by means of light and sound. When some sort of accident happens in the shop floor 7, the warning light 71 attracts the attention of people around by the color and sound selected depending on the severity of accident. For example, when the worker 9 collapses, the monitoring apparatus 30 controls the warning light 71 to be turned on.

The beacon transmitter 73 detects the position of the terminal device 10. The beacon transmitter 73 transmits a radio or radar signal that is referred to as beacon to a prescribed range around at regular time intervals, and the terminal device 10 that enters the prescribed range receives the beacon. The beacon includes an output level and position information such as latitude and longitude. The terminal device 10 can calculate an approximate distance from the beacon transmitter 73 based on the ratio of the strength of the received radio or radar signal to the output level. Accordingly, the terminal device 10 can detect the position of the terminal device 10 itself based on the position of the beacon transmitter 73. When the terminal device 10 is provided with a satellite position determination device such as a global positioning system (GPS), the beacon transmitter 73 may be omitted.

The terminal device 10 is a portable information processing device. The terminal device 10 may be a device dedicated to the worker data detection system 100 or a general-purpose device. The general-purpose device may be, for example, a so-called smart device such as a smartphone, tablet personal computer (PC), a mobile phone, a wearable personal computer (PC), a personal digital assistant (PDA), a handy terminal, or a laptop personal computer (PC), which are small enough to be carried by a user. While the dedicated device has functions equivalent to those of the smart device, the general-purpose device may be used not only for the worker data detection system 100 but also for other purposes by executing a plurality of applications. By contrast, the dedicated device is different from the general-purpose device as the dedicated device is used only for the worker data detection system 100.

The terminal device 10 is provided with a sensor that obtains worker data. For example, the terminal device 10 is provided with a triaxial acceleration sensor, a triaxial gyroscope sensor, a triaxial geomagnetic sensor, and an air pressure sensor.

The terminal device 10 may be, for example, a music player, an activity tracker, and a wristwatch, other than the examples given as above. Note also that the terminal device 10 is not limited to one device. There are some cases in which the worker 9 wears a plurality of terminal devices 10 that are adapted to detect the worker data.

The monitoring apparatus 30 is an information processing device that monitors the work of the worker 9 based on the worker data. There may be some cases in which the monitoring apparatus 30 is referred to as a server. The server provides some sort of data or some sort of results of processes in response to a request from a client device connected through the network. The monitoring apparatus 30 is illustrated as one device in FIG. 2, however, it is desired that the monitoring apparatus 30 be adapted to cloud computing. The term cloud computing refers to Internet-based computing where the resources in the network are used or accessed without identifying specific hardware resources.

For the above reasons, the hardware components of the monitoring apparatus 30 do not have to be accommodated in a single housing or provided as a group of devices or apparatuses. For example, the hardware resources of the monitoring apparatus 30 may be dynamically connected or disconnected depending on the load. Alternatively, the monitoring apparatus 30 may be built in a virtual environment of one physical computer, or the functions of a single monitoring apparatus 30 may be built across a plurality of physical computers.

<Hardware Configuration>

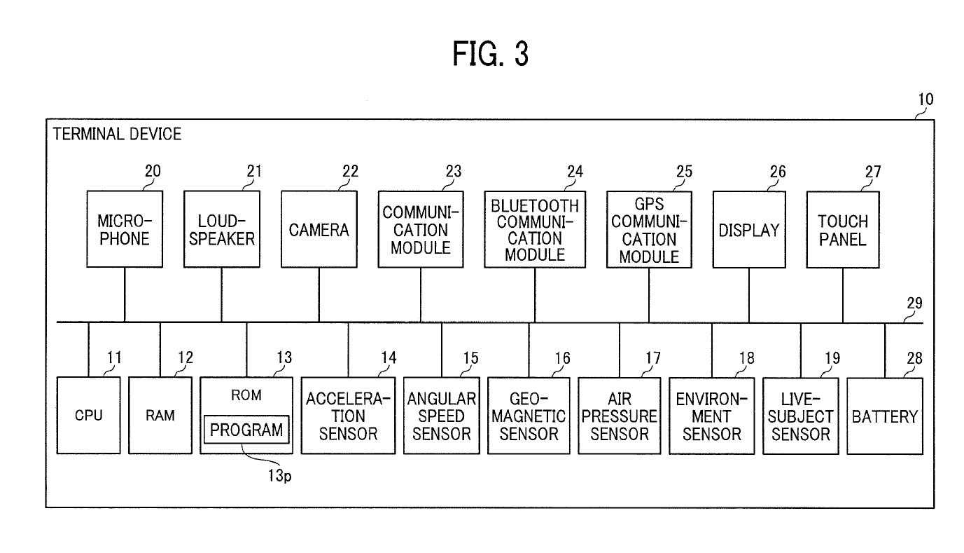

Next, the hardware configuration of the terminal device 10 according to the present embodiment is described with reference to FIG. 3.

FIG. 3 is a schematic block diagram illustrating a hardware configuration of the terminal device 10, according to the present embodiment.

The terminal device 10 includes a central processing unit (CPU) 11, a random access memory (RAM) 12, a read-only memory (ROM) 13, an acceleration sensor 14, an angular speed sensor 15, a geomagnetic sensor 16, an air pressure sensor 17, an environment sensor 18, a live-subject sensor 19, a microphone 20, a loudspeaker 21, a camera 22, a communication module 23, a Bluetooth (registered trademark) communication module 24, a global positioning system (GPS) receiving module 25, a display 26, a touch panel 27, a battery 28, and a bus 29.

The CPU 11 executes a program for controlling the operation of the terminal device 10. The RAM 12 serves as a work area or the like of the CPU 11. The ROM 13 stores a program 13p to be executed by the CPU 11 or data used to execute the program 13p. The acceleration sensor 14 detects the acceleration of the terminal device 10 along three axes. The angular speed sensor 15 (or a gyroscope sensor) detects the angular speeds of the rotation around the three axes of the terminal device 10. The geomagnetic sensor 16 outputs a three-dimensional vector that indicates the magnetic north, and detects the direction of the terminal device 10. The air pressure sensor 17 measures the air pressure, and detects the altitude of the terminal device 10.

The environment sensor 18 is a sensor that obtains the information about the working environment of the worker 9, and is for example, a temperature sensor, a hydrometer, and an actinometer. The live-subject sensor 19 is a sensor that obtains the physical data of the worker 9, which is referred to as vital data, and measures, for example, the pulse, the breathing rate, the body temperature, the level of oxygen concentration in the blood, an electrocardiogram (ECG), and the blood pressure.

A wristband sensor is known in the art as the live-subject sensor 19, and such a wristband sensor can detect the pulse or the like even during the sleep at home. The live-subject sensor 19 has a built-in acceleration sensor, and is able to measure the sleeping hours based on the changes in acceleration. The live-subject sensor 19 and the terminal device 10 perform short-range communication such as Bluetooth to communicate with each other, and thus the terminal device 10 can send the data detected by the live-subject sensor 19 to the monitoring apparatus 30.

The microphone 20 is a device that picks up ambient sounds and convert the sounds into electrical signals. The loudspeaker 21 outputs sound by converting the voice data (digital data) into analog data and vibrating a diaphragm. The camera 22 is provided with an imaging element such as a charge coupled device (CCD) and a complementary metal oxide semiconductor (CMOS), and concentrates the incident light onto a lens to convert the light into brightness data on a pixel-by-pixel basis.

The communication module 23 is connected to a wireless local area network (LAN) or a switched line network such as a third generation ( 3 G) network or a long term evolution (LTE) network, and communicates with an external device. The bluetooth communication module 24 is a device that perform communication using wireless communication standard called Bluetooth, and receives a beacon from the beacon transmitter 73 as above.

The GPS receiving module 25 is a device that receives the position determination signals sent from a global positioning system (GPS) satellite or the Indoor MEssaging System (IMES).

The display 26 is a device that displays the screen for a user. The touch panel 27 is a device that receives an input from a user. The battery 28 is a device that supplies the terminal device 10 with driving power. The bus 29 connects the multiple devices, excluding the battery 28, with each other.

Instead of the Bluetooth communication module 24, the terminal device 10 may be provided with another device that performs radio communication according to different standards (for example, ZigBee (registered trademark) communication module).

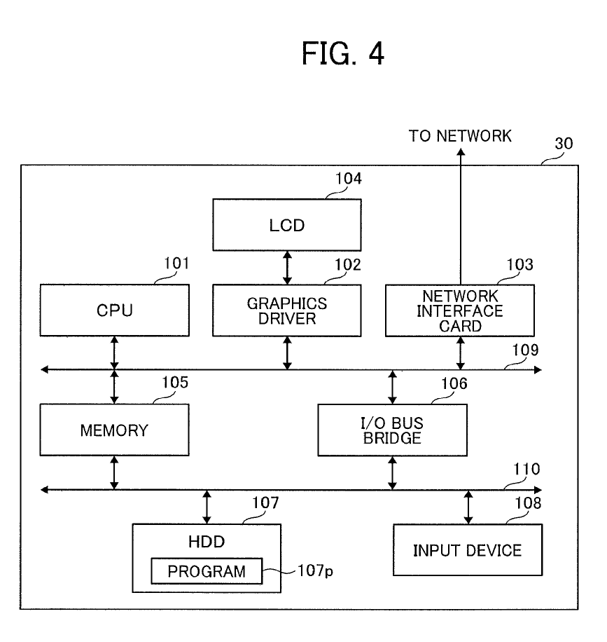

FIG. 4 is a schematic block diagram illustrating a hardware configuration of the monitoring apparatus 30 according to the present embodiment.

The monitoring apparatus 30 according to the present embodiment may substantially be implemented as a personal computer (PC), a workstation, or an appliance server. The monitoring apparatus 30 is provided with a central processing unit (CPU) 101 and a memory 105 that enables the CPU 101 to access the data at high speed. The CPU 101 and the memory 105 are connected to other devices or drivers of the monitoring apparatus 30, for example, a graphics driver 102 and a network interface card (NIC) 103, through a system bus 109.

The graphics driver 102 is connected to a liquid crystal display (LCD) 104 through a bus, and monitors the results of processes that are performed by the CPU 101. The network interface card 103 connects the monitoring apparatus 30 to a network N at the transport layer level and at the physical layer level to establish a session between the monitoring apparatus 30 and the terminal device 10.

Further, an input-output (I/O) bus bridge 106 is connected to the system bus 109. On the downstream side of the input-output (I/O) bus bridge 106, a storage device such as hard disk (HD) and a hard disk drive (HDD) 107 is connected through an input-output (I/O) bus 110 such as peripheral component interconnect (PCI), using, for example, Integrated Drive Electronics (IDE), Advanced Technology Attachment (ATA), ATA Packet Interface (ATAPI), Serial AT Attachment (SATA), Small Computer System Interface (SCSI), and Universal Serial Bus (USB). The HDD 107 stores a program 107p for controlling the entirety of the monitoring apparatus 30.

An input device 108 such as a keyboard and a mouse (also referred to as a pointing device) is also connected to the input-output (I/O) bus 110 through a bus such as USB, and the input device 108 accepts commands or inputs from an operator such as the administrator 8.

Basically, the hardware configuration of the administrator's PC 50 is equivalent to that of the monitoring apparatus 30. Even if the hardware configuration of the administrator's PC 50 is different from that of the monitoring apparatus 30, a description of the present embodiment is given under the assumption that such a difference is insignificant.

<Functions>

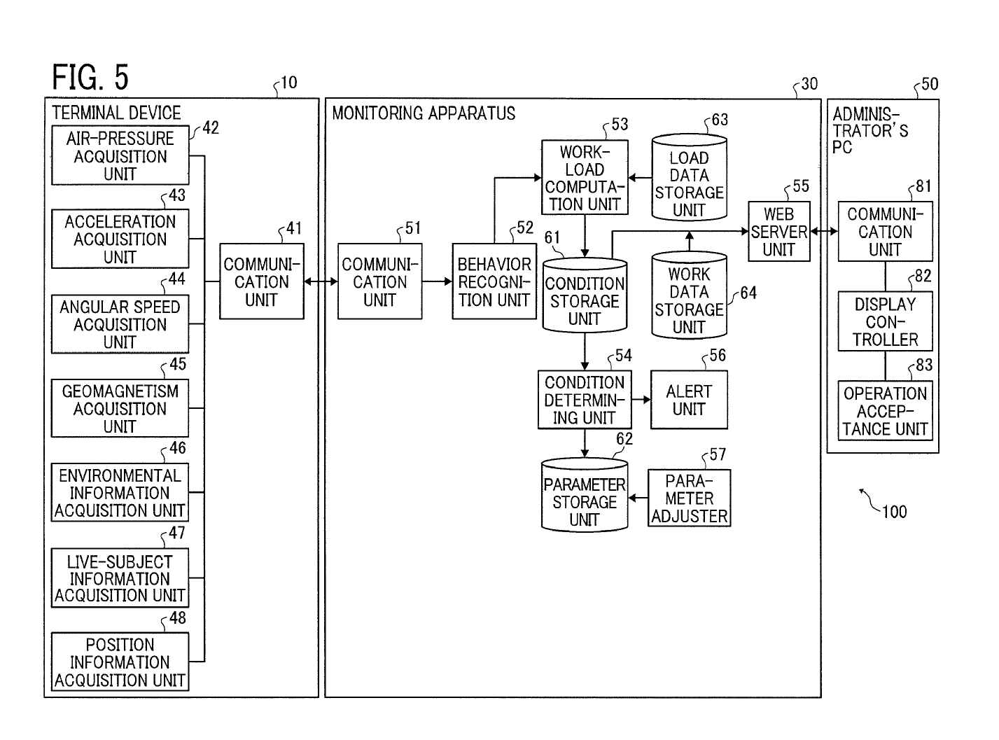

Next, the functions of the terminal device 10 and the monitoring apparatus 30 are described with reference to FIG. 5.

FIG. 5 is a functional block diagram of the terminal device 10, the monitoring apparatus 30, and the administrator's PC 50, according to the present embodiment.

The terminal device 10 includes a communication unit 41, an air-pressure acquisition unit 42, an acceleration acquisition unit 43, an angular speed acquisition unit 44, a geomagnetism acquisition unit 45, an environmental information acquisition unit 46, a live-subject information acquisition unit 47, and a position information acquisition unit 48. These functional units of the terminal device 10 are functions or units that are implemented by or caused to function by operating some of the elements illustrated in FIG. 3 under the control of the instructions from the CPU 11. Note also that such instructions from the CPU 11 are made in accordance with the program 13p expanded from the ROM 13 to the RAM 12. The program 13p may be distributed from a server for program distribution, or may be distributed in a state where the program 13p is stored in a storage medium. This program may be referred to as an application in the following description.

The communication unit 41 may be implemented as, for example, the CPU 11 illustrated in FIG. 3 executes the program 13p to control the communication module 23, and the communication unit 41 exchanges various kinds of data with the monitoring apparatus 30. In the present embodiment, the communication unit 41 transmits the worker data and receives a warning.

The air-pressure acquisition unit 42 may be implemented as, for example, the CPU 11 illustrated in FIG. 3 executes the program 13p to control the air pressure sensor 17, and the air-pressure acquisition unit 42 obtains the air pressure detected by the air pressure sensor 17.

The acceleration acquisition unit 43 may be implemented as, for example, the CPU 11 illustrated in FIG. 3 executes the program 13p to control the acceleration sensor 14, and the acceleration acquisition unit 43 obtains the acceleration detected by the acceleration sensor 14.

The angular speed acquisition unit 44 may be implemented as, for example, the CPU 11 illustrated in FIG. 3 executes the program 13p to control the angular speed sensor 15, and the angular speed acquisition unit 44 obtains the angular speed detected by the angular speed sensor 15.

The geomagnetism acquisition unit 45 may be implemented as, for example, the CPU 11 illustrated in FIG. 3 executes the program 13p to control the geomagnetic sensor 16, and the geomagnetism acquisition unit 45 obtains the magnetism of the earth detected by the geomagnetic sensor 16.

The environmental information acquisition unit 46 may be implemented as, for example, the CPU 11 illustrated in FIG. 3 executes the program 13p to control the environment sensor 18, and the environmental information acquisition unit 46 obtains the environmental information detected by the environment sensor 18. The environmental information indicates, for example, the temperature, the humidity, and the solar radiation at the shop floor 7.

The live-subject information acquisition unit 47 may be implemented as, for example, the CPU 11 illustrated in FIG. 3 executes the program 13p to control the live-subject sensor 19, and the live-subject information acquisition unit 47 obtains the live-subject information detected by the live-subject sensor 19. The live-subject information indicates the vital data such as the pulse of the worker.

The position information acquisition unit 48 may be implemented as, for example, the CPU 11 illustrated in FIG. 3 executes the program 13p to control the GPS receiving module 25, and the position information acquisition unit 48 obtains the position information of the terminal device 10. Alternatively, the position information acquisition unit 48 calculates and obtains the position information based on the beacon received by the Bluetooth communication module 24 from the beacon transmitter 73.

In the present embodiment, at least one of the air pressure, the acceleration, the angular speed, and the magnetism of the earth is used as the worker data. It is satisfactory as long as some of those elements of the worker data as above is appropriately used to monitor the load of the worker 9. The air-pressure acquisition unit 42, the acceleration acquisition unit 43, the angular speed acquisition unit 44, and the geomagnetism acquisition unit 45 continuously obtain the worker data. The term “continuously” does not only mean “without interruption” but also means “intermittently at some time intervals” as if the worker data is obtained continuously.

Moreover, the time intervals at which the air-pressure acquisition unit 42, the acceleration acquisition unit 43, the angular speed acquisition unit 44, and the geomagnetism acquisition unit 45 obtain the worker data are not necessarily constant. For example, when the worker data changes to a large degree, the time intervals at which the worker data is obtained may be shortened. By contrast, when the worker data is stable, the time intervals at which the worker data is obtained may be expanded. Whether the worker data is changing to a large degree or stable may be determined by comparing a derivative value with respect to time or a second derivative value with respect to time with a threshold. By so doing, the consumption of the battery 28 can be reduced.

The timings at which the air-pressure acquisition unit 42, the acceleration acquisition unit 43, the angular speed acquisition unit 44, and the geomagnetism acquisition unit 45 obtain the worker data, or the time intervals at which the air-pressure acquisition unit 42, the acceleration acquisition unit 43, the angular speed acquisition unit 44, and the geomagnetism acquisition unit 45 obtain the worker data may be similar to each other or may be different from each other.

It is desired that the communication unit 41 send the worker data to the monitoring apparatus 30 in real time. However, the communication unit 41 may send the worker data at a time after a certain amount of worker data is accumulated. By so doing, the consumption of the battery 28 can be reduced, and congestion of the communication band can be relieved. Under conditions where the radio communication is impaired (for example, when the access point 72 is out of order or when the communication band is congested), the worker data is accumulated and the communication unit 41 sends the accumulated worker data when the communication is recovered.

The environmental information and the position information may have longer time intervals at which information or data is detected and longer time intervals at which information or data is sent than the worker data. This is because it is not much necessary to repeat assessing the working environment or location within a short period of time. Regarding the live-subject information, it is satisfactory as long as the live-subject information is sent, for example, once a day in the mornings. This is because, as will be described later in detail, the live-subject information is used to estimate the degree of recovery from fatigue during sleep. However, it is still preferable that the live-subject information be monitored at all times during the work.

The monitoring apparatus 30 includes a communication unit 51, a behavior recognition unit 52, a work-load computation unit 53, a condition determining unit 54, an alert unit 56, a parameter adjuster 57, and a web server unit 55. These functional units of the monitoring apparatus 30 are functions or units that are implemented by or caused to function by operating some of the elements illustrated in FIG. 4 under the control of the instructions from the CPU 101. Note also that such instructions from the CPU 101 are made in accordance with the program 107p expanded from the HDD 107 to the memory 105. The program 107p may be distributed from a server for program distribution, or may be distributed in a state where the program 107p is stored in a storage medium.

Moreover, the monitoring apparatus 30 includes a condition storage unit 61, a parameter storage unit 62, a load data storage unit 63, and a work data storage unit 64. Each of these storage units is configured in at least one of the HDD 107 and the memory 105 illustrated in FIG. 4 as a database. Firstly, the condition storage unit 61, the parameter storage unit 62, the load data storage unit 63, and the work data storage unit 64 are described in detail.

TABLE 1A

| Posture | Loading Unit |
|---|---|
| Bending Forward | 1.5/minute |
| Squatting | 1.5/minute |
| Bending Backward | 0.2/minute |
| Walking | 0.05/step |
| Going Up Stairs | 0.3/step |
| Going Down Stairs | 0.1/step |
| Pushing Hand Cart | 0.2/step |
| Seated | −1.0/minute |
| Nap | −5.0/minute |

TABLE 1B

| | |
|---|---|
| Air Temperature | α |
| Humidity | β |
| Solar Radiation | γ |

Table 1A depicts in tabular form the loading unit of each posture stored in the load data storage unit 63. As will be described later in detail, the posture indicates behavior that the worker 9 takes to do his/her work or operation. The loading unit is a value for conversion used to indicate how much load one unit of posture could be. The value of one unit is set in an appropriate way of counting for each posture. For example, one unit of the bending forward, squatting, and bending backward postures is a period of time (e.g., one minute), and one unit of the walking, going up the stairs, going down the stairs, and pushing a handcart is one step. As described above, the monitoring apparatus 30 can convert postures into loads in an appropriate way of counting selected for each one of the postures.

The loading unit of being seated and having a nap takes a negative (minus) value. This indicates that a posture of being seated and a posture of having a nap reduces the load (recovery from fatigue). As some postures have a negative value, the monitoring apparatus can accumulate the load more accurately.

It is assumed that, for example, the administrator 8 of the worker data detection system 100 determines the value of each loading unit in advance in view of the actual load on the worker 9 caused by each posture.

Table 1B depicts the environmental coefficients stored in the load data storage unit 63. The loading unit is multiplied by the environmental coefficients when the worker 9 works in tough (heavy-load) working environments. For example, the environmental coefficients are determined with reference to air temperature, humidity, and solar radiation. When the air temperature, humidity, and the solar radiation exceeds a predetermined environment threshold, the environmental coefficients are used. In Table 1, 30 degrees Celsius (° C.), 55%, and 0.8 [kilowatt (kW)/meter (m)²] are the environment thresholds.

When the air temperature exceeds 30 degrees Celsius, the loading unit is multiplied by the environmental coefficient α. When the humidity exceeds 55%, the loading unit is multiplied by the environmental coefficient β. When the amount of solar radiation exceeds 0.8 [kW/m²], the loading unit is multiplied by the environmental coefficient γ. Each one of the environmental coefficients α, β, and γ has a value greater than 1, for example, about 1.1 to 3.0.

When some of the values in the environmental information of the worker 9 exceed a plurality of environment thresholds of the air temperature, humidity, and the amount of solar radiation, the largest environmental coefficient is used. In Table 1B, one environmental coefficient is set to each of the air temperature, humidity, and the amount of solar radiation.

However, the air temperature, humidity, and the amount of solar radiation may be divided into multiple levels, and an environmental coefficient may be set to each one of the multiple levels of the air temperature, humidity, and the amount of solar radiation.

TABLE 2A

| Time | Posture | Position Information |
|---|---|---|
| 9:10:15 | Bending Forward | 35° 40′ 52.673″ N |
| | | 139° 45′ 58″ E |
| 9:10:16 | Bending Forward | 35° 40′ 52.673″ N |
| | | 139° 45′ 58″ E |
| . . . | . . . | . . . |
| 9:13:18 | Bending Forward | 35° 40′ 52.673″ N |
| | | 139° 45′ 58″ E |
| 9:20:35 | Walking | 35° 41′ 52.673″ N |
| | | 139° 46′ 58″ E |
| . . . | . . . | . . . |
| 9:20:45 | Walking | 35° 41′ 52.673″ N |
| | | 139° 46′ 58″ E |
| . . . | . . . | . . . |

TABLE 2B
Worker ID: 001

| Posture | Cumulative Hours | Load |
|---|---|---|
| Bending Forward | 12 minutes | 18 |
| Squatting | 5.5 minutes | 8.25 |
| Seated | 10 minutes | −10 |
| Going Up Stairs | 100 steps | 30 |
| walking | 500 steps | 25 |
| | Cumulative Load | 71.25 |

TABLE 2C
Worker ID: 002

| Posture | Cumulative Hours | Load |
|---|---|---|
| Bending Forward | 5 minutes | 7.5 |
| Squatting | 3 minutes | 4.5 |
| Seated | 9 minutes | −9 |
| Going Up Stairs | 100 steps | 30 |
| walking | 400 steps | 20 |
| | Cumulative Load | 53 |

Table 2B depicts the chronological posture information stored in the condition storage unit 61. In the chronological posture information of each worker 9, the recognized postures and the position information are chronologically recorded with respect to time. For example, bending forward posture is firstly recognized at 9:10:15 (hour:minute:second), and the bending forward posture is lastly recognized at 9:13:18. The minimum value for time intervals at which posture is checked is dependent on time intervals at which the terminal device 10 sends the worker data. Basically, the monitoring apparatus 30 recognizes the posture as long as the worker data is being sent. However, for cases in which changes in posture are exceptionally small, the monitoring apparatus 30 may detect posture at regular time intervals. As the position information is given, at what position the posture is recognized is also apparent.

Table 2B depicts the calculated load data stored in the condition storage unit 61. The calculated load data of each worker 9 includes the total hours of each posture, and the load and the cumulative load that are calculated based on the posture and its total hours. In other words, how long the worker 9 has taken each posture in total recorded, and the load caused by each posture is recorded. The cumulative load indicates the value of the sum total of the loads of each posture.

Table 2C depicts the calculated load data of another worker stored in the condition storage unit 61. The cumulative load of a worker in Table 2B is 71.25, and the cumulative load of another worker in Table 2C is 53. For example, assuming that a threshold such as the first threshold, as will be described later in detail, is 60, no warning is sent to the worker with the worker ID of 001, and a warning is sent to the worker with the worker ID of 002. As described above, whether or not to send a warning can be determined on a worker-by-worker basis.

The worker ID in Tables 2A, 2B, and 2C, the worker ID is data that identifies each worker. The term “ID” is an abbreviation of identification meaning identifier or identification information. ID may be a name, code, text, numerical value, or a combination of any of these name, code, text, and the numerical value, which is used to uniquely distinguish a specific object from other multiple objects.

TABLE 3

| | Worker ID = 001 | | Worker ID = 002 | |
|---|---|---|---|---|
| Age | 35 | | 27 | |
| Sex | Male | | Female | |
| Work Experience | 10 Years and 5 | | 5 Years and 10 | |
| | Months | | Months | |
| Weight | 65 kg | | 48 kg | |
| Height | 170 cm | | 155 cm | |
| Strength for Operation | Large | | Small | |
| Threshold | Basic | One-day | Basic | One-day |
| First Threshold | 100 | 100 | 80 | 80 |
| Second Threshold | 150 | 150 | 120 | 120 |
| Third Threshold | 200 | 200 | 120 | 120 |

| | | |
|---|---|---|
| History of Accidents | Moderate | Minor |
| | 2016 Sep. 25 | 2016 Sep. 25 |
| | Major | — |
| | 2013 Mar. 15 | |

Table 3 depicts the parameters stored in the parameter storage unit 62. The parameters include the characteristics, strength for operation, a threshold for warning, and the history of accidents of each worker 9. The characteristics may include, for example, age, sex, work experience, weight, and height, but no limitation is intended thereby. The characteristics of each worker 9 are used to determine the threshold.

The strength for operation indicates whether the tolerance of load of the worker 9 is high or low, and is determined in view of, for example, the sex, physical fitness (strength), and the willingness to work of the worker 9. For example, the strength for operation is set to be high when the worker 9 is a male. Even if the worker 9 is a male, the strength for operation may be set to be low, for example, when he reports that his strength for operation should be low according to his self-assessment, or when he has just come back from the rest and recuperation due to illness. On the other hand, the strength for operation is set to be low when the worker 9 is a female. However, even if the worker 9 is a female, the strength for operation may be set to be high, for example, when the evaluation of her physical fitness indicates that her strength for operation should be high, or when she reports that his strength for operation should be high according to her self-assessment. As the work experience becomes longer, for example, the work performance in the past tends to be taken into consideration rather than the fact that the worker 9 is a male or a female.

The first to third thresholds may be set. Each one of the first to third thresholds is compared with the cumulative load. The first warning is sent out when the cumulative load exceeds the first threshold, and the second warning is sent out when the cumulative load exceeds the second threshold. The third warning is sent out when the cumulative load exceeds the third threshold. As described above, step-by-step warning is enabled due to those multiple thresholds.

The first threshold is to call attention to the work. In other words, the first threshold deals with the cumulative load considered to indicate tiredness accumulated to a slight degree. Due to the first warning, the worker 9 can recognize his/her accumulated tiredness. It is known in the art that recognition of tiredness itself leads to reduction in making a mistake. Accordingly, warning may prevent an accident. The second threshold deals with the cumulative load considered to indicate tiredness accumulated to a large degree. Due to the second warning, the worker 9 can recognize his/her accumulated tiredness, and can take a rest or drink some liquid. The third threshold deals with the cumulative load considered to cause an accident. For example, rules may be established that, basically, the worker 9 has to take a rest at least for fixed period of time when the worker 9 receives the third warning. Due to such rules, it becomes easy to prevent an accident.

For the sake of explanatory convenience, three thresholds are set in the above embodiment. However, it is satisfactory as long as at least one threshold is set. Alternatively, four or more thresholds may be set.

The categories of threshold include the basic threshold and the threshold for that day (one-day threshold). The basic threshold is determined by the work performance of the worker 9 in the past. The threshold for that day (one-day threshold) is a threshold to be used when the worker 9 works in a tough (heavy-load) environment. Accordingly, when the worker 9 does not work in a tough (heavy-load) environment, the basic threshold is equal to the threshold for that day (one-day threshold).

As described above, the worker data detection system 100 according to the present embodiment gives warning to the worker 9 on an as-needed basis, for example, when the cumulative load reaches some thresholds. Accordingly, accidents can be prevented from happening.

The history of accidents indicates the record of the accidents that the worker 9 has caused in the past. The date or the date and time of each accident is included in the history of accidents, and the history of accidents is referred to, for example, when a threshold is to be determined. The term “accident” indicates a bad event in which someone is injured or something is damaged without anyone intending them to be. The term “incident” includes a situation in which an accident did not happen in actuality but it could possibly lead to a serious accident. The detail of an actual accident may vary according to the type of operation, but an accident indicates a situation where an optimum result is not achieved in an operation. For example, in an accident, parts are selected in error in picking operation, and delivery is done to a wrong destination in carrying operation. Moreover, an accident includes a situation where the worker 9 collapses, is injured, or complains of poor physical condition. Further, an accident includes, for example, a loss of equipment, damage to equipment, and having trouble with a coworker.

The accidents are classified into, for example, “major”, “moderate”, and “minor” depending on the degree of seriousness. Alternatively, the administrator 8 may judge the accidents at his/her discretion.

TABLE 4

| Posture | Operation |
|---|---|
| Bending Forward | e.g., Picking Operation, |
| Squatting | Restocking Products |
| Bending Backward | |
| Walking | e.g., Carrying Operation, |
| Going Up Stairs | Moving |
| Pushing Handcart | |
| Seated | e.g., Resting |
| Nap | |

Table 4 depicts an example of posture-operation information stored in the work data storage unit 64. The posture-operation information is the information where the postures and the operations are associated with each other. The term “operation” in the posture-operation information indicates a job that the worker 9 does as business operations. The operation consists of one or more postures. For example, in the case of picking operation, the worker 9 may take a bending forward (bowing), squatting, or bending backward posture. In the case of carrying operation, the worker 9 may walk, go up and down the stairs, or push a handcart.

As the monitoring apparatus 30 can convert a posture into a concrete operation with reference to the posture-operation information, the administrator 8 can figure out what the operation of the worker 9 could be. When the cumulative load is high or an accident has happened, the operation can be changed to another operation where appropriate.

The communication unit 51 may be implemented as, for example, the CPU 101 illustrated in FIG. 4 executes the program 107p to control the network interface card 103, and the communication unit 51 exchanges various kinds of data with the terminal device 10. In the present embodiment, the communication unit 51 receives the worker data and sends a warning.

The behavior recognition unit 52 may be implemented as, for example, the CPU 101 illustrated in FIG. 4 executes the program 107 p, and the behavior recognition unit 52 recognizes the posture of the worker 9 with reference to the worker data. The behavior recognition unit 52 chronologically monitors the worker data to recognize the posture in a continuous manner. While the worker data is being input, the behavior recognition unit 52 continuously recognize recognizable postures. Note that some of the postures require the passage of time to be recognized. For this reason, it is desired that the behavior recognition unit 52 recognize the posture upon buffering the worker data in the memory 105 for, for example, several seconds to the degree of about one minute.

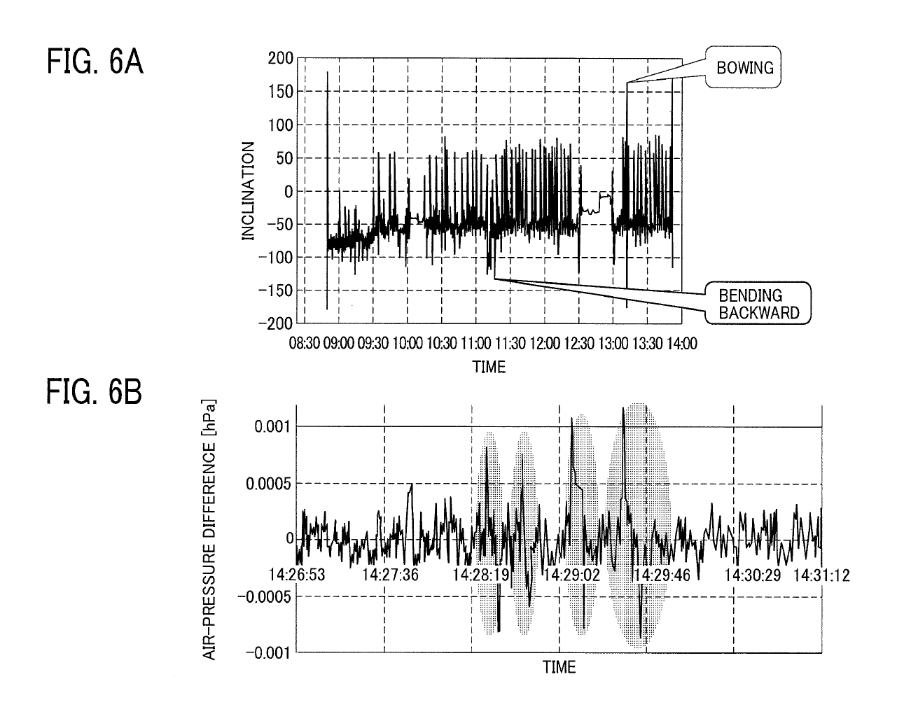

The condition storage unit 61 stores the posture recognized by the behavior recognition unit 52, as chronological posture information. The posture may be, for example, one of a bending forward posture, a squatting posture, a bending backward posture, walking, going up the stairs, going down the stairs, pushing a handcart, being seated, and having a nap, as depicted in Table 1A. However, no limitation is intended thereby, and any posture that could be taken during the work may be included. One posture may further be classified into several categories. A posture recognition method will be described in detail with reference to FIG. 6A and FIG. 6B.

The work-load computation unit 53 may be implemented as, for example, the CPU 101 illustrated in FIG. 4 executes the program 107p, and the work-load computation unit 53 computes the cumulative load based on the posture recognized by the behavior recognition unit 52. The work-load computation unit 53 reads the chronological posture information, and calculates the total cumulative hours of each posture. The work-load computation unit 53 reads the loading unit of each posture, and multiplies the total cumulative hours of each posture by the read loading unit. By so doing, the load is calculated for each posture. The loads of each posture are summed up to calculate the cumulative load. Such calculated load data as above is stored in the condition storage unit 61.

The condition determining unit 54 may be implemented as, for example, the CPU 101 illustrated in FIG. 4 executes the program 107 p, and the condition determining unit 54 determines whether or not there is a possibility that the worker 9 causes an accident, based on the cumulative load. In other words, the cumulative load is compared with each one of the first to third thresholds stored in the parameter storage unit 62.

The alert unit 56 may be implemented as, for example, the CPU 101 illustrated in FIG. 4 executes the program 107p, and the alert unit 56 sends a warning to the worker 9 when the condition determining unit 54 determines that the cumulative load has exceeded one of the first to third thresholds. Alternatively, the alert unit may send a warning to the administrator. Basically, warning is achieved by sending a warning message to the terminal device 10 or the administrator's PC 50. However, in cases where the worker 9 has collapsed, the warning light 71 is activated to attract the attention of people around.

The parameter adjuster 57 may be implemented as, for example, the CPU 101 illustrated in FIG. 4 executes the program 107 p, and the parameter adjuster 57 switches the threshold of the worker 9 every time the alert unit 56 sends a warning. In other words, when the cumulative load exceeds the first threshold, the alert unit 56 switches the first threshold to the second threshold. When the cumulative load exceeds the second threshold, the alert unit 56 switches the second threshold to the third threshold. The parameter adjuster 57 may determine the threshold on an individual basis according to, for example, the age, sex, and the work experience of each worker 9, or may determine the initial value for the cumulative load in view of the tiredness (fatigue) of the worker 9.

The web server unit 55 may be implemented as, for example, the CPU 101 illustrated in FIG. 4 executes the program 107 p, and the web server unit 55 provides the administrator's PC 50 or the terminal device 10 with a web page or web application. The web server unit 55 refers to the condition storage unit 61, and provides the administrator's PC 50 with, for example, the cumulative load of a plurality of workers 9.

The administrator's PC 50 includes a communication unit 81, a display controller 82, and an operation acceptance unit 83. These functional units of the administrator's PC 50 are functions or units that are implemented by or caused to function by operating some of the elements illustrated in FIG. 4 under the control of the instructions from the CPU 101. Note also that such instructions from the CPU 101 are made in accordance with the program 107p expanded from the HDD 107 to the memory 105. The program 107p may be distributed from a server for program distribution, or may be distributed in a state where the program 107p is stored in a storage medium. This program may be referred to as an application in the following description.

The communication unit 81 may be implemented as, for example, the CPU 101 illustrated in FIG. 4 executes the program 107p to control the network interface card 103, and the communication unit 81 exchanges various kinds of data with the monitoring apparatus 30. In the present embodiment, the communication unit 81 receives a web page or a web application.

The display controller 82 may be implemented as, for example, the CPU 101 illustrated in FIG. 4 executes the program 107p to control the graphics driver 102, and the display controller 82 draws various kinds of screen images on the LCD 104.

The operation acceptance unit 83 may be implemented as, for example, the CPU 101 illustrated in FIG. 4 executes the program 107p to control the input device 108, and the operation acceptance unit 83 receives various kinds of operation or input made by the administrator.

<Posture Recognition Method>

Next, an example of a posture recognition method is described with reference to FIG. 6A and FIG. 6B.

FIG. 6A is a diagram illustrating recognition of bowing or bending backward posture, according to the present embodiment.

In FIG. 6A, the horizontal axis indicates time, and the vertical axis indicates the inclination of the terminal device 10. The behavior recognition unit 52 calculates the inclination of the terminal device 10 based on the worker data. More specifically, The behavior recognition unit 52 calculates the inclination of the terminal device 10 based on the acceleration detected by the acceleration sensor 14 and the magnetic north detected by the geomagnetic sensor 16.

When the worker 9 takes a bending forward posture, the inclination of the terminal device 10 takes a value in a certain range. In other words, when the worker 9 takes a bending forward posture, the inclination of the terminal device 10 takes a value that is shifted from the inclination that is substantially considered to be the reference value (i.e., −50 degrees in FIG. 6A) to the positive side. When the inclination takes a value larger than the reference value, the behavior recognition unit 52 recognizes that the worker 9 has taken the bending forward posture.

When the worker 9 takes a bending backward posture, the inclination of the terminal device 10 takes a value in a certain range in the direction opposite to that of the bending forward posture. In other words, the inclination of the terminal device 10 takes a value that is shifted from the inclination that is substantially considered to be the reference value (i.e., −50 degrees in FIG. 6A) to the negative side. When the inclination takes a value smaller than the reference value, the behavior recognition unit 52 recognizes that the worker 9 has taken the bending backward posture.

FIG. 6B is a diagram illustrating recognition of squat posture, according to the present embodiment.

In FIG. 6B, the horizontal axis indicates time, and the vertical axis indicates the air-pressure difference. The air-pressure difference is a chronological air-pressure difference. The air pressure differs even with a difference in height of a person. For this reason, when the worker 9 squats, the air pressure that is detected by the air pressure sensor 17 changes. The air pressure is high on the lower side, and the air pressure is low on the upper side. Accordingly, when the worker 9 squats and an air pressure at a chronologically earlier time is subtracted from an air pressure at a chronologically later time, the obtained air-pressure difference takes a positive value. By contrast, the air-pressure difference takes a negative value when the worker 9 stands up.

The behavior recognition unit 52 recognizes a squatting posture by detecting a pair of an air-pressure peak (positive value) when squatting and an air-pressure peak (negative value) when standing up after the squatting. Although squatting is recognized after the standing up action is done, the period of time between the start of squatting and the standing up action is recognized as a squat posture afterward.

Other postures are recognized as follows.

### Walking

A walking posture is recognized based on the acceleration detected by the acceleration sensor 14 and the angular speed detected by the angular speed sensor 15. For example, when acceleration equal to or greater than a predetermined value in the up-and-down directions is detected and side-to-side swinging (rolling) unique to human walking is detected, walking is detected.

### Moving Up and Down Stairs

When the worker 9 moves up and down the stairs, acceleration and angular speed are detected in a similar manner to the detection of walking. In the case of going up-and-down the stairs, the air pressure further changes and acceleration in the up-and-down directions, which cannot be caused by walking, is caused. Accordingly, when side-to-side swing equivalent to walking, acceleration in the up-and-down directions, which is stronger than walking, and changes in air pressure are detected, the behavior recognition unit 52 recognizes a posture of going up-and-down the stairs. Note also that the reduction in air pressure indicates going up the stairs, and the increase in air pressure indicates going down the stairs.

### Seated

When the worker 9 is seated, acceleration is firstly detected in the downward direction and then stability is detected. After the worker 9 is seated, the inclination of the terminal device 10 becomes stable at a value different from the reference value. Accordingly, the behavior recognition unit 52 recognizes that the worker 9 is seated when acceleration is firstly detected in the downward direction, stability is then detected, and finally the inclination becomes stable at a value different from the reference value.

In order to prevent an accident and improve the efficiency, the worker data detection system 100 according to the present embodiment can determine an environmental coefficient to calculate the threshold, the initial value for the cumulative load, and the load. All of these are factors to adjust how soon the cumulative load will reach the threshold.

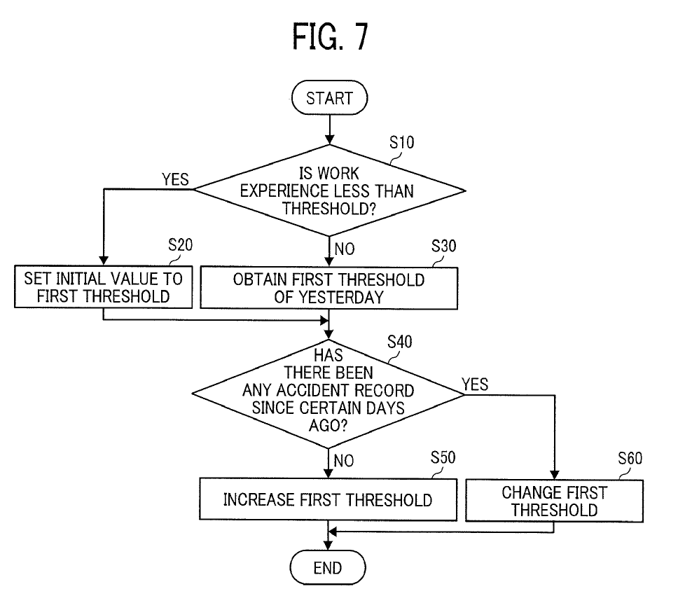

It is desired that the first to third thresholds be determined appropriately so as to prevent an accident and improve the efficiency. The basic concepts are as follows. It is considered that a higher threshold can be set to the worker 9 who is considered to be experienced in operations or has great physical strength or fitness. On the other hand, it is considered that a lower threshold is to be set to the worker 9 who has recently caused an accident. Accordingly, a warning can be sent to the worker 9 at an early stage. Following is the description of how a threshold is determined with reference to the flowchart of FIG. 7.

FIG. 7 is a flowchart of procedure for determining the threshold by the parameter adjuster 57, according to the present embodiment.

The processes in FIG. 7 are to be executed before the working hours start.

Firstly, the parameter adjuster 57 refers to the parameter storage unit 62, and determines whether or not the work experience is less than a threshold (S10 of FIG. 7). When the work experience is less than a threshold, it is estimated that the worker 9 is inexperienced with the work, and thus it is desired that the worker 9 be warned at an early stage. The threshold for the work experience is, for example, about one month to one year.

When it is determined to be “YES” in the step S10 of FIG. 7, the parameter adjuster 57 sets an initial value to the first threshold (S20 of FIG. 7). Regarding the second threshold and the third threshold, the description will be given later. The first threshold that serves as the initial value is determined based on the characteristics of the worker 9. As merely an example, calculation is as follows. Firstly, the characteristics of the worker 9 are converted into points.

### Age

16 to 22 years old: 3 points

23 to 45 years old: 4 points

46 to 55 years old: 3 points

55 to 60 years old: 2 points

### Sex

Male: 4 points

Female: 2 points

### Weight

Under 39 kg: 2 points

40 to 55 kg: 3 points

56 to 80 kg: 5 points

81 to 90 kg: 3 points

Over 91 kg: 2 points

### Height

Under 150 cm: 2 points

151 to 160 cm: 3 points

161 to 180 cm: 5 points

Over 181 cm: 4 points

The parameter adjuster 57 may classify the sum of the points of the characteristics into on the order of three levels, and determines the first threshold depending on the level to which the sum of the points belongs. For example, the ratio of the total point of each worker to the maximum of 18 (4+4+5+5=18) that the sum of the points of characteristics including age, sex, weight, and height could take is calculated. For example, the first threshold may be set to 100 when the above ratio is equal to or greater than 90%, and the first threshold may be set to 80 when the above ratio is between 80 to 90%. The first threshold may be set to 60 when the above ratio is less than 60%. As the first threshold is updated according to the work performance, the initial value of the first threshold is not necessarily very accurate. After that, the process proceeds to the step S40 of FIG. 7.

When it is determined to be “NO” in the step S10 of FIG. 7, the parameter adjuster 57 obtains the first threshold of yesterday from the parameter storage unit 62 (S30 of FIG. 7). By determining the first threshold of that day using the first threshold of yesterday, the first threshold has continuity and can be optimized for each worker 9.

Next, the parameter adjuster 57 determines whether or not there has been an accident record since certain days ago (S40 of FIG. 7). The term “certain days ago” may indicate, for example, the previous day in the business days, one week ago, or one month ago.

When it is determined to be “YES” in the step S40 of FIG. 7, the parameter adjuster 57 changes the first threshold according to the date and time in the history of accidents (S60 of FIG. 7). When the date and time of the accident indicates yesterday, the first threshold is reduced by 20%. In the other cases, the first threshold is not changed. By so doing, the first threshold can be decreased on the day after the accident, and the first threshold remains the same afterward at a certain value. Accordingly, the monitoring apparatus 30 can send a warning at an early stage to a worker who has caused an accident, and accidents can more easily be prevented from happening.

When it is determined to be “NO” in the step S40 of FIG. 7, the parameter adjuster 57 increases the first threshold in view of the work experience (S50 of FIG. 7). For example, when the work load is large, the first threshold is increased by 2% each. When the work load is small, the first threshold is increased by 1% each. Due to this configuration, the first threshold of the worker 9 who continuously proceeds with work without causing an accident increases on a daily basis. Accordingly, the worker 9 can work without a break, and the efficiency of the worker 9 improves.

The first threshold that is determined as above serves as a basic threshold of the parameter storage unit 62. From tomorrow onward, the first threshold is further adjusted based on the first threshold determined as in FIG. 7.

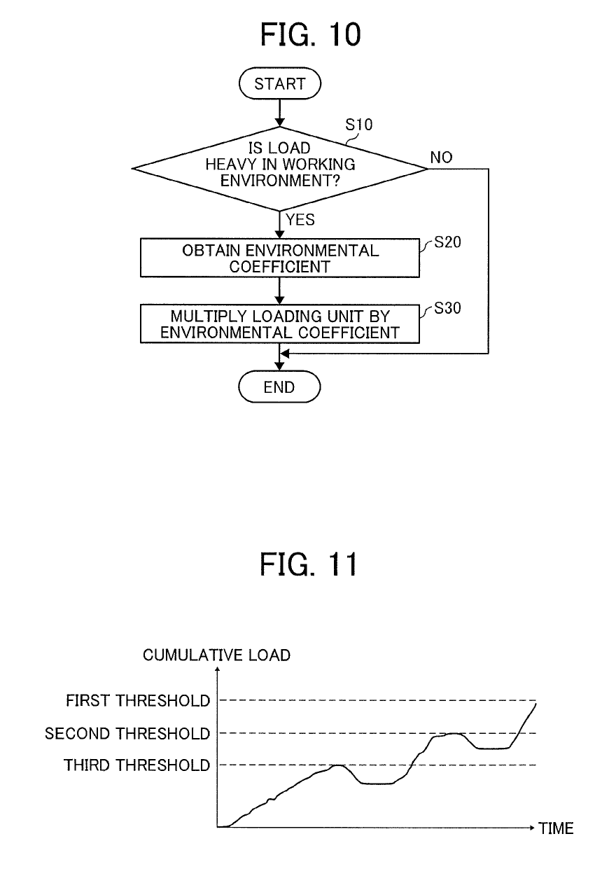

The first threshold that serves as a basic criterion for warning is determined as above. However, when the operation on that day is to be done in touch (heavy-load) environments, there may be some cases in which it is desired that the first threshold be changed. For example, there are some operations that have to be done in tough (heavy-load) working environments where the temperature or humidity is high. In such environments, it is considered that the load of the worker 9 is rapidly accumulated. For this reason, the work-load computation unit 53 according to the present embodiment may multiply the loading unit by the environmental coefficient that depends on the working environment such that the cumulative load that is close to the actual cumulative load of the worker 9 will be calculated (see FIG. 10).

However, the cumulative load tends to be accumulated rapidly in tough (heavy-load) working environments. Accordingly, there is some concern that the cumulative load reaches the third threshold before the operations are completed. In order to handle such a situation, the first threshold is temporarily changed in the case of tough (heavy-load) working environments. Accordingly, accidents can be prevented from happening, and the efficiency improves.

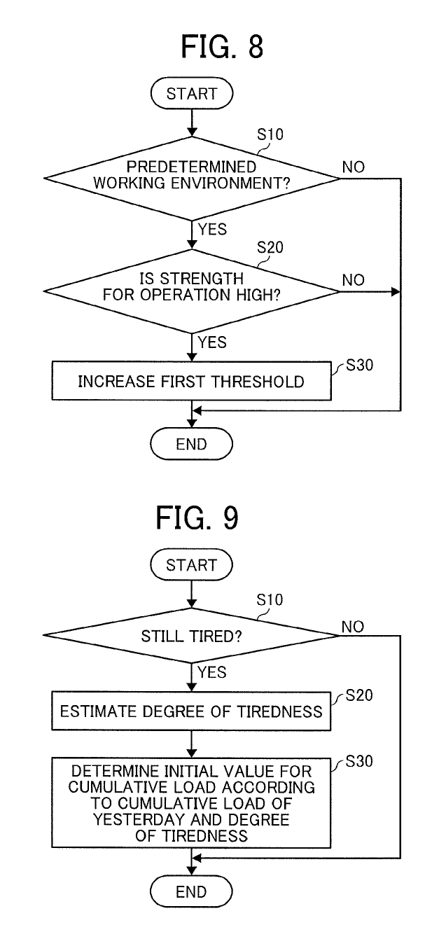

FIG. 8 is a flowchart of procedure for temporarily changing the threshold depending on the working environment, by the parameter adjuster 57, according to the present embodiment.

For example, the processes in FIG. 8 are executed after the processes in FIG. 7.

Firstly, the parameter adjuster 57 determines whether or not the worker 9 is to work in a predetermined working environment (S10 of FIG. 8). Some predetermined working environments are registered with the worker data detection system 100 in advance as heavy load shop floors. The working environment of the worker 9 for that day is determined by the administrator 8 or the like by the day before that day, and is registered with a duty roster. The parameter adjuster 57 refers to this duty roster, and determines whether or not the worker 9 is to work in a predetermined working environment. Alternatively, whether or not the worker 9 is to work in a predetermined working environment may be determined according to the position information (e.g., location of room number) of the worker 9 on that day. Such determination can be made depending on whether the position information is included in the shop floor 7 of the predetermined working environment (e.g., room number). When it is determined to be “NO” in the step S10 of FIG. 8, the first threshold is unchanged and thus the processes in FIG. 8 end.

When it is determined to be “YES” in the step S10 of FIG. 8, the parameter adjuster 57 refers to the parameter storage unit 62, and determines whether or not the strength for operation of the worker 9 is high (S20 of FIG. 8).

When the strength for operation is high, it is considered that the worker 9 has a high tolerance of load and the worker 9 will not cause an accident even if the threshold is increased for a short time (for example, for one day). For this reason, when it is determined to be “YES” in the step S20 of FIG. 8, the parameter adjuster 57 increases the first threshold (S30 of FIG. 8). For example, the first threshold may be increased by about 20% to 50%. Further, the amount of increment may be adjusted in view of the characteristics of the worker 9. For example, as the total point calculated based on the characteristics of the worker 9 as above is higher, the amount of increment is increased.

When it is determined to be “NO” in the step S20 of FIG. 8, the first threshold is unchanged and thus the processes in FIG. 8 end. When the strength for operation is low, the first threshold is unchanged (not reduced). However, the cumulative load rapidly increases due to the environmental coefficient. Accordingly, the worker 9 whose strength for operation is small can be prevented from becoming ill.

Even if the load is rapidly accumulated in the processes of FIG. 8 due to the predetermined working environment, when the strength for operation of the worker 9 is high, the efficiency can easily be maintained. When the strength for operation of the worker 9 is low, the first threshold is unchanged, and thus warning is done at an early stage and accidents can be prevented from happening.

<<Initial Value of Cumulative Load>>

Basically, the initial value for the cumulative load starts from zero. This is because it is considered that the load is reset by sleep on a daily basis. However, for example, when the worker 9 cannot have sleeping hours sufficient to recover from fatigue or when the cumulative load of yesterday was eventually extremely high, the worker 9 may still be tired since yesterday when the worker 9 starts working. In such cases, it is expected that the monitoring apparatus 30 gives an early warning to prevent an accident.

In order to deal with such a situation, the worker data detection system 100 according to the present embodiment adjusts the initial value for the cumulative load when the worker 9 is still tired since yesterday.

FIG. 9 is a flowchart of procedure for determining the initial value of the cumulative load by the parameter adjuster 57, according to the present embodiment.

The processes in FIG. 9 are to be executed before the working hours start or after the working hours end within a predetermined length of time.

Firstly, the parameter adjuster 57 determines whether or not the worker 9 is still tired since yesterday (S10 of FIG. 9). Tiredness or fatigue may be detected in various ways using, for example, the following data.

### Resting Heart Rate

The heart rate tends to be high at the time of wake-up when he or she fails to recover from fatigue. If the live-subject sensor 19 of the terminal device 10 has measured a heart rate at the time of wake-up (resting heart rate) under normal conditions, the parameter adjuster 57 can compare the actual heart rate with a normal average heart rate. When the heart rate is significantly high, it is determined that the worker 9 is tired.

### Sleeping Hours

People recover from fatigue during sleeping hours. For this reason, when the sleeping hours is too short, it is highly likely that he/she has not yet recovered from fatigue. If the terminal device 10 has measured the sleeping hours under normal conditions, it is possible to detect short sleeping hours that are shorter than the sleeping hours under normal conditions by at least a predetermined length of time. Various kinds of methodologies have been proposed for measuring the sleeping hours, but for example, the terminal device 10 of a wristwatch type determines that the time periods during which the acceleration sensor 14 detects no acceleration are the sleeping hours. Alternatively, the terminal device 10 that is placed at one's bedside observes and measures faint irregularities in radio wave to determine whether or not the worker 9 is sleeping. By so doing, the sleeping hours can be measured.

### Walking Speed

When in fatigue, it is known that the walking speed tends to slow down. As the terminal device 10 can detect the position information, the terminal device 10 can measure in advance the walking speed during the move from home to the place of work or the walking speed at the place of work. Accordingly, it is possible to detect the walking speed that is slower than usual by at least a predetermined speed.

### Deflection of Center of Gravity

When in fatigue, it is known that the center of gravity tends to swing or deflect to right and left while walking. As the terminal device 10 can detect, for example, the acceleration to the right and left directions and a roll angle, the terminal device 10 can measure in advance the deflection of the center of gravity during the move from home to the place of work or the deflection of the center of gravity at the place of work. Accordingly, it is possible to detect the deflection that is greater than usual by at least a predetermined degree.

Then, the parameter adjuster 57 puts all these elements together to determine whether or not the worker 9 is still tired and estimate the degree of tiredness. For example, the parameter adjuster 57 determines that the worker 9 is still tired when the heart rate is higher than usual, when the sleeping hours is shorter than usual, when the walking speed is slower than usual, or when the deflection of the center of gravity is larger than usual.

When he/she is still tired (“YES” in S10 of FIG. 9), the parameter adjuster 57 estimates the degree of tiredness (S20 of FIG. 9). For example, the degree of tiredness is calculated as follows.
When the heart rate is higher than usual

To a large degree: 5 points

To a middle degree: 4 points

To a small degree: 3 points
When the sleeping hours is shorter than usual

To a large degree: 5 points

To a middle degree: 3 points

To a small degree: 2 points
When the walking speed is slower than usual

To a large degree: 3 points

To a middle degree: 2 points

To a small degree: 1 point
When the deflection of the center of gravity is larger than usual

To a large degree: 4 points

To a middle degree: 3 points

To a small degree: 2 points

The parameter adjuster 57 sums up these points, and estimates the sum total to be the degree of tiredness.

Then, the parameter adjuster 57 determines the initial value for the cumulative load according to the cumulative load of yesterday and the degree of tiredness (S30 of FIG. 9).

For example, about 20 % of the cumulative tiredness on the previous day, at maximum, may be set to the initial value of the cumulative load. As the maximum value of the sum total of the tiredness points as above is as follows.

5+5+3+4=17

Accordingly, the initial value of the cumulative load may be determined as follows.

Initial Value of Cumulative Load={(Degree of Tiredness/17)×0.2}×Cumulative Tiredness on Previous Day

As described above, as the cumulative load on the previous day is greater and the tiredness is greater, the initial value of the cumulative load on that day can be increased. Accordingly, the monitoring apparatus 30 can warn the worker 9 who is still tired since yesterday at an earlier stage, and accidents can be prevented from happening.

It is to be noted that setting the initial value of the cumulative load to a value other than zero and reducing the first to third thresholds for that day bring about a similar effect. Accordingly, the parameter adjuster 57 may reduce the first to third thresholds for that day. However, it is considered to be natural that the initial value of the cumulative load is not zero when the worker 9 is still tired. For this reason, the parameter adjuster 57 changes the initial value of the cumulative load in the present embodiment.

<<Setting Environmental Coefficient>>

The cumulative load is calculated according to the loading units that are determined on a posture-by-posture basis, but it is considered that loads more than the loading units are accumulated on the worker 9 who works in tough (heavy-load) working environments where the temperature or humidity is high.

In order to deal with such a situation, the work-load computation unit 53 may multiply the loading unit by the environmental coefficient that depends on the working environment such that the cumulative load reflects the tough (heavy-load) working environments. Due to this configuration, the cumulative load increases at an earlier stage in tough (heavy-load) working environments, and it is considered that the cumulative load becomes close to the load that is actually accumulated on the worker 9. Accordingly, accidents can more easily be prevented from happening.

FIG. 10 is a flowchart of procedure for calculating the load in view of the working environment by the work-load computation unit 53, according to the present embodiment.

The processes in FIG. 10 are performed in the processes of calculating the cumulative load.

Firstly, the work-load computation unit 53 in view of the environmental information sent from the terminal device 10 and the environmental coefficients stored in the load data storage unit 63, determines whether or not the load is heavy in the working environment (S10 of FIG. 10). In other words, whether or not at least one of the air temperature, humidity, and the amount of solar radiation exceeds the environment threshold is determined.

When it is determined to be “NO” in the step S10 of FIG. 10, it is not necessary to use the environmental coefficient, and thus the processes in FIG. 10 end.

When it is determined to be “YES” in the step 510 of FIG. 10, the work-load computation unit 53 obtains an environmental coefficient from the load data storage unit 63 (S20 of FIG. 10). In other words, one of the environmental coefficients α, β, and γ is selected depending on which one of the air temperature, humidity, and the amount of solar radiation exceeds the environment threshold. When two or more of the air temperature, humidity, and the amount of solar radiation exceed the environment threshold, the largest environmental coefficient is used.

Then, the work-load computation unit 53 multiplies the loading unit by the environmental coefficient to compute the load of each posture (S30 of FIG. 10). The loads of each posture are summed up and the cumulative load is obtained.

As described above, the use of an environmental coefficient enables the cumulative load to reflect the working environment, and accidents can more easily be prevented from happening.

<First Threshold, Second Threshold, and Third Threshold>

The first threshold, the second threshold, and the third threshold are prepared in order to prevent an accident by giving step-by-step warnings as above.

FIG. 11 is a diagram illustrating the relation among the first threshold, the second threshold, and the third threshold, according to the present embodiment.

FIG. 11 schematically illustrates the relation between the time and the cumulative load. The first threshold, the second threshold, and the third threshold are depicted as the cumulative load. The worker 9 who has been warned due to the first threshold takes a rest or the like, and thus the cumulative load decreases. When the cumulative load exceeds the second threshold after the worker 9 starts the work again, the worker 9 is warned. The worker 9 takes a rest or the like, and thus the cumulative load decreases. Further, when the cumulative load exceeds the third threshold after the worker 9 starts the work again, the worker 9 is warned.

As the warnings according to the present embodiment are performed in order to prevent an accident, it is desired that the warnings be done at an early stage. Even if the worker 9 takes some rest after the first warning due to the first threshold, the worker 9 is still tired to some degree. For this reason, it is desired that the difference between the first threshold and the second threshold be smaller than the first threshold. In other words, the second warning is done in a shorter period of time than the period of time between the start of the work and the first warning. As the load to the to the degree of the first threshold has already been accumulated in the worker 9, the second threshold is determined as above to prevent an accident.

The third threshold is determined in a similar manner to the second threshold, and it is desired that the difference between the second threshold and the third threshold be smaller than the first threshold. In particular, the thresholds are determined as follows.

Second Threshold=First Threshold+First Threshold/2

Third Threshold=Second Threshold+First Threshold/2

In other words, the difference between the first threshold and the second threshold and the difference between the second threshold and the third threshold are half the first threshold.

Alternatively, the difference between the first threshold and the second threshold and the difference between the second threshold and the third threshold may be, for example, one-third (⅓) of the first threshold. Moreover, the difference between the first threshold and the second threshold is not necessarily the same as the difference between the second threshold and the third threshold. For the sake of warning at an earlier stage, it is desired that the difference between the second threshold and the third threshold be smaller than the difference between the first threshold and the second threshold. Due to such a configuration, the second warning and the third waring are done at an earlier stage, and thus accidents can more easily be prevented from happening.

As described above, the second threshold and the third threshold can appropriately be determined based on the first threshold. Alternatively, instead of determining the first threshold according to the service record (work record) in the past, the third threshold may be determined according to the service record (work record) in the past. In such a configuration, the first threshold may be half the third threshold, and the second threshold may be the first threshold to which half the first threshold is added.

<Overall Operation>

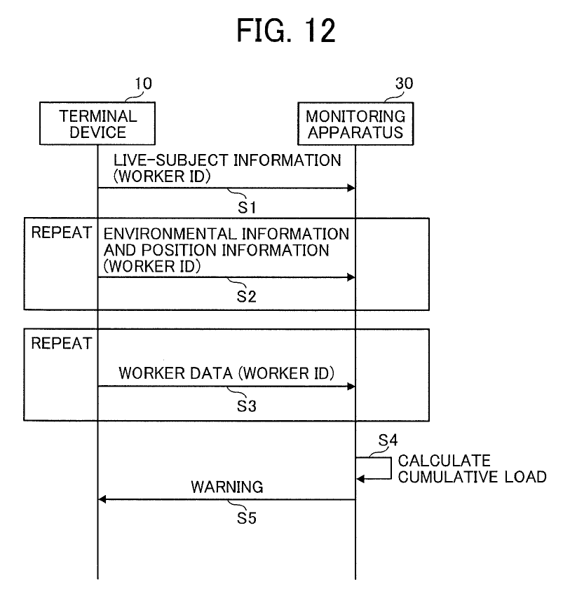

FIG. 12 is a data sequence diagram illustrating overall operation of the worker data detection system 100, according to the present embodiment.

The processes in FIG. 12 start when the worker 9 has done preparation for work at his/her place of work and starts the terminal device 10 or an application.

S1: The communication unit 41 of the terminal device 10 sends the worker ID and the live-subject information to the monitoring apparatus 30.

S2: The communication unit 41 of the terminal device 10 sends the worker ID as well as the environmental information and the position information to the monitoring apparatus 30. Note also that the environmental information and the position information are repeatedly sent at predetermined frequency.

S3: The communication unit 41 of the terminal device 10 sends the worker ID and the worker data to the monitoring apparatus 30. Note also that the worker data is repeatedly sent at predetermined frequency.

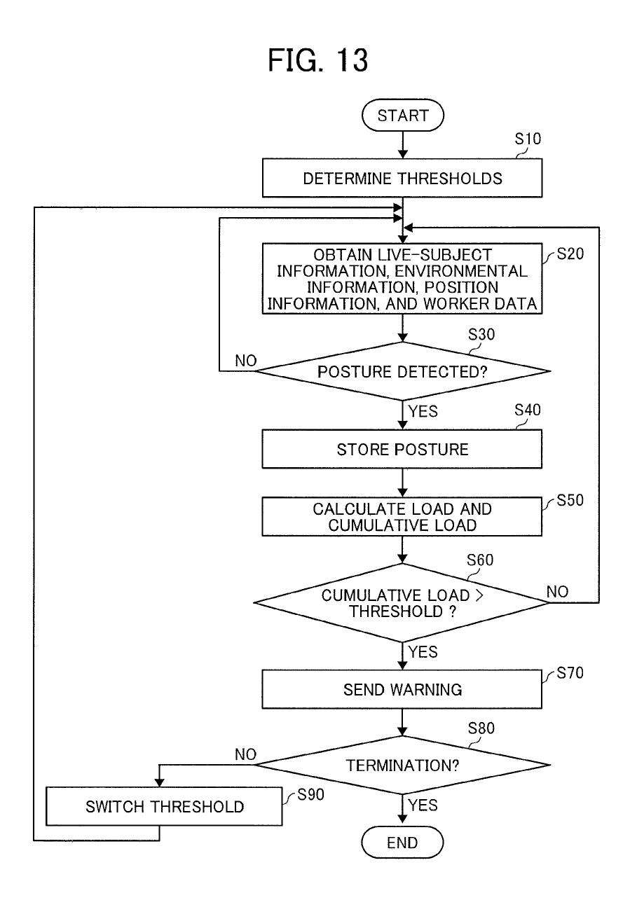

S4: The communication unit 51 of the monitoring apparatus 30 receives the live-subject information, the environmental information, the position information, and the worker data. Then, the behavior recognition unit 52 recognizes the posture, and the work-load computation unit 53 performs, for example, the calculation of cumulative load. The calculation of cumulative load will be described later in detail with reference to FIG. 13.

S5: The alert unit 56 of the monitoring apparatus 30 sends a warning to the terminal device 10 when the cumulative load exceeds one of the first threshold to the third threshold.

FIG. 13 is a flowchart of procedure for calculating the cumulative load to give warning, by the monitoring apparatus 30, according to the present embodiment.

First of all, as described above, the parameter adjuster 57 determines the first to third thresholds (S10 of FIG. 13). Then, the parameter adjuster 57 switches between the basic threshold and the threshold for that day in view of the working environment.

Then, as described above, the communication unit 51 receives the live-subject information, the environmental information, the position information, and the worker data (S20 of FIG. 13). The parameter adjuster 57 refers to the live-subject information, and calculates the initial value for the cumulative load.

The behavior recognition unit 52 determines whether or not a posture to be recognized is detected based on the worker data (S30 of FIG. 13). When it is determined to be “NO” in the step S30 of FIG. 13, a posture to be recognized is kept being detected.

When it is determined to be “YES” in the step S30 of FIG. 13, the behavior recognition unit 52 instructs the condition storage unit 61 to store the recognized posture together with the time and the position information (S40 of FIG. 13). The behavior recognition unit 52 updates the total cumulative hours of each posture (or the total number of steps for going-up stairs and walking) based on the recognized posture.

Next, the work-load computation unit 53 calculates the load for each posture using a loading unit, and sums up the load for each posture to calculate the cumulative load (S50 of FIG. 13). At this point, the environmental coefficient is selected based on the environmental information.

Next, the condition determining unit 54 determines whether or not the cumulative load exceeds the first threshold (S60 of FIG. 13). When it is determined to be “NO” in the step S60 of FIG. 13, the process returns to the step S20 of FIG. 13.

When it is determined to be “YES” in the step S60 of FIG. 13, the alert unit 56 sends a warning (S70 of FIG. 13).

Then, the monitoring apparatus 30 determines whether or not to terminate the process (S80 of FIG. 13). The processes in FIG. 13 are terminated, for example, when a terminating notice is sent from the terminal device 10. Such a terminating notice is sent, for example, when the worker 9 terminates the application or when the worker 9 turns off the terminal device 10.

When it is determined to be “NO” in the step S80 of FIG. 13, as a warning is sent, the parameter adjuster 57 switches the threshold that serves as criteria for judgment, from the first threshold to the second threshold (S90 of FIG. 13).

As described above, the monitoring apparatus 30 calculates the cumulative load while recognizing the posture, and sends a warning when the cumulative load exceeds a threshold. Further, the threshold can be switched when a warning is sent.

<Information given to Administrator's PC 50>

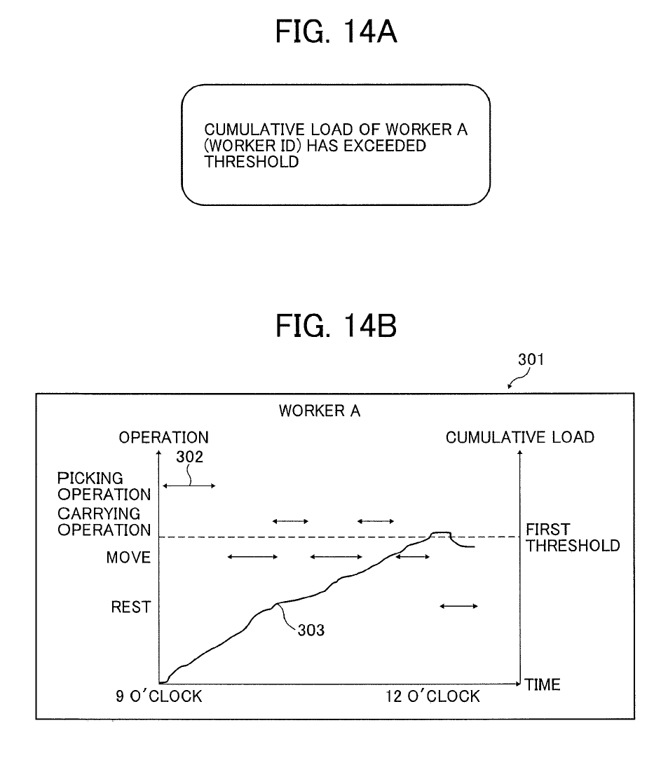

FIG. 14A is a diagram depicting a warning displayed on the administrator's PC 50, according to the present embodiment.

Such a warning may be given to the terminal device 10. The terminal device 10 regularly communicate with the monitoring apparatus 30, and when the alert unit 56 of the monitoring apparatus 30 sends a warning to the terminal device 10, the terminal device 10 can receive such a warning in real time. A warning may be sent, for example, via electronic mail. The warning includes, for example, a message saying “The cumulative load of worker A (worker ID) has exceeded the first threshold”. For example, the worker 9 may take a rest or the administrator 8 may let the worker 9 to take a rest when the worker 9 or the administrator 8 sees such a message as above.

FIG. 14B is a diagram illustrating a personal load screen 301 provided by the web server unit 55, according to the present embodiment.

The communication unit 81 of the administrator's PC 50 obtains from the monitoring apparatus 30 the screen data described by HyperText Markup Language (HTML), script language, or cascading style sheets (CSS), and controls a display to display the personal load screen 301. On the personal load screen 301, the horizontal axis, the vertical axis on the left, and the vertical axis on the right indicate the time, the work, and the cumulative load, respectively. What kinds of work are done by the worker 9 in what time zone are indicated by arrows 302. Moreover, how the cumulative load 303 increases with respect to time is illustrated in FIG. 14B.

When the administrator 8 figures out that the worker 9 takes a lot of tough postures (with heavy load) such as a picking operation, for example, the administrator 8 can assign different operation to the worker 9 as a measure to deal with this problem. As the relation between the work and the cumulative load is displayed, the administrator 8 can identify a tough operation (with heavy load), and for example, the administrator can reassign the worker 9 to different operations such that tough operations (with heavy load) will not be accumulated on a specific worker 9. By so doing, accidents can be prevented from happening.

In FIG. 14B, the names of postures may be listed instead of the names of operation. However, it is difficult for the administrator 8 to figure out what kind of operation is being done when the names of postures are listed. In this respect, it is preferable that the names of operation are displayed. It is even more preferable if the administrator 8 can switch between the display of the name of operation and the display of the name of postures.

The personal load screen 301 as illustrated in FIG. 14B is generated by the web server unit 55 using a web page or a web application. Firstly, the administrator 8 operates the administrator's PC 50 to send the worker ID to the monitoring apparatus 30. The web server unit 55 reads the chronological posture information from the condition storage unit 61 using the worker ID as a key. Secondly, the loading unit of each posture is obtained from the load data storage unit 63 to calculate the cumulative load. Note that the cumulative load may be multiplied by an environmental coefficient. Due to the configuration as described above, the cumulative load that is associated with the time can be obtained. Moreover, the posture-operation information that is stored in the work data storage unit 64 is obtained, and the postures in the chronological posture information are converted into operation. Due to this configuration, the operation that is associated with the time can be obtained.

<Conversion of Performance into Numbers>

The monitoring apparatus 30 can convert the performance of the worker 9 into the form of numbers. When the worker 9 is in a posture whose loading unit takes a positive value, it is considered that the worker 9 is doing some sort of operation. On the contrary, when the worker 9 is in a posture whose loading unit takes a negative value, it is considered that the worker 9 is not doing any sort of operation. Conventionally, it was difficult to convert how much work the worker 9 is doing into the form of numbers. As the cumulative load is recorded in the present embodiment, the performance can be converted into numbers, and the obtained numbers can be compared with each other among workers. The performance may be, for example, the cumulative load per unit time. It is considered that the worker 9 has done a greater amount of work per unit time as the cumulative load per unit time is heavier.

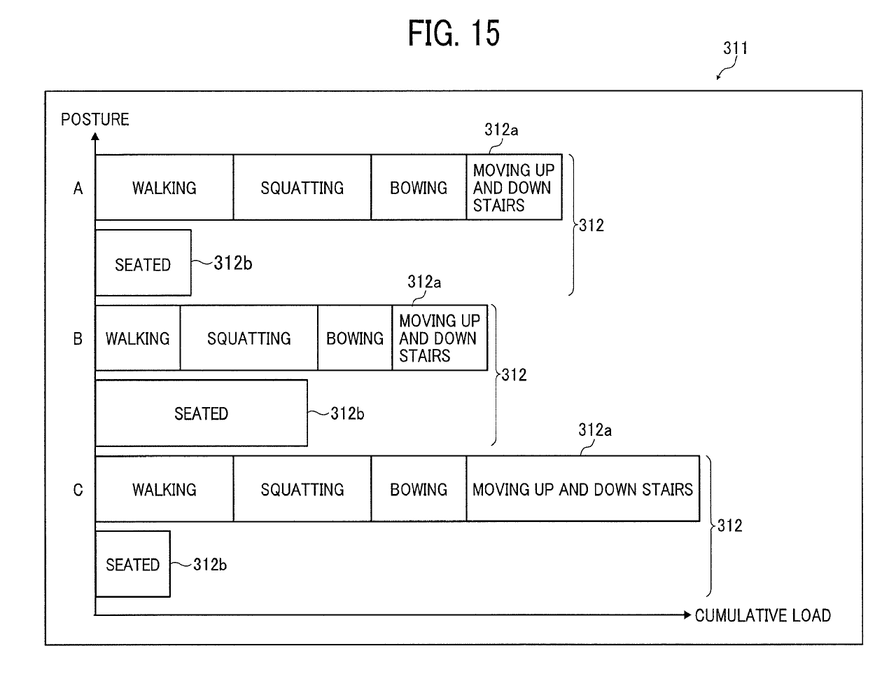

FIG. 15 is a diagram illustrating a comparison screen 311 on which the cumulative loads of a plurality of workers 9 in a day are tabulated for comparison, according to the present embodiment.

For example, the cumulative loads and the names of the workers 9 are depicted in the horizontal axis and the vertical axis of the comparison screen 311, respectively. The cumulative load of each worker 9 is illustrated as in bar charts 312, indicating the cumulative load of several postures on one day. Two bar charts are given to each worker 9, and postures 312a of positive values and a posture 312b of a negative value are separately illustrated in an upper bar chart and a lower bar chart, respectively.

Accordingly, the one-day cumulative load is greater for the worker 9 with a longer upper bar chart, and the one-day break time is longer for the worker 9 with a longer lower bar chart. When the cumulative load on the upper side is large, it is likely that the worker 9 is occupied with a lot of work of some kind, and thus it is estimated that the performance of that worker 9 is high. When the cumulative load on the lower side is large, it is likely that the worker 9 is not occupied with much work, and thus it is estimated that the performance of that worker 9 is low.

For example, the administrator 8 can determine the wage of the worker 9 in view of the comparison screen 311, or can give guidance to the worker 9 whose cumulative load on the lower side is greater compared with the cumulative load on the upper side.

There are some cases in which the worker 9 works on a job-by-job basis or on a service-by-service basis. For example, there are some cases in which a job in which a pair of parts is passed to a next step, a job in which products are shipped, or a service of attending to customers is to be repeated. In such cases, if the number of jobs or services output by the worker 9 is counted, the monitoring apparatus 30 (or the administrator's PC 50) can calculate and obtain the cumulative load for each job or each service. Cumulative Load for each Job or each Service=(Cumulative Load on Upper Side−Cumulative Load on Lower Side)/Number of Jobs or Services

As the cumulative load for each job or service is smaller, it can be estimated that the efficiency is higher. As it becomes apparent as to how much load is accumulated by each worker 9 for each job or each service, the administrator 8 can judge that the worker 9 whose cumulative load for each job is significantly large tends to do a lot of needless actions, and can give such a worker guidance.

For example, in picking operation, there should be optimal arrangement of parts in which operations can be done in an efficient manner. However, such arrangement tends to be relied upon somebody's experience. In the present embodiment, the monitoring apparatus 30 can suggest optimal arrangement of parts using the position information of the worker 9.

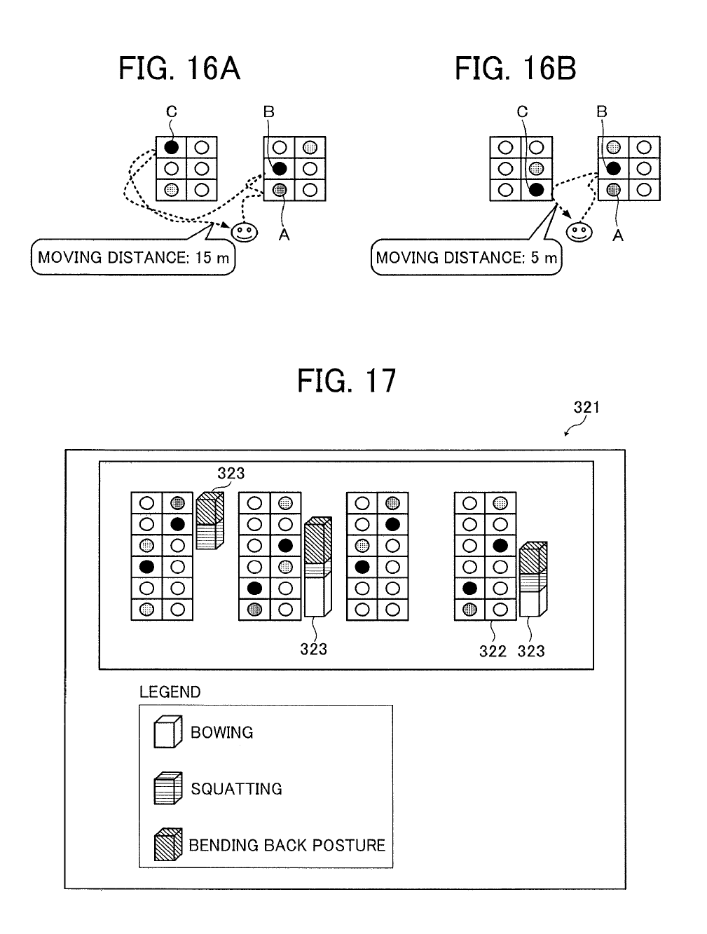

FIG. 16A and FIG. 16B are diagrams illustrating an example in which the moving distances that vary depending on the location of parts are compared with each other.

FIG. 16A illustrates an example in which moving distance is long, and FIG. 16B illustrates an example in which moving distance is short. In FIG. 16A and FIG. 16B, the worker 9 picks up parts A, B, and C. For example, the moved distance is 15 meters (m) in FIG. 16A, and the moved distance is 5 m in FIG. 16B. In other words, even when the same three parts are picked up, the moving distance greatly varies depending on the arrangement of these parts.

For example, in the case of picking operation, the worker 9 is provided with instructions at a fixed place, and outputs the picked up parts to a next step. Then, the worker 9 is provided with next instructions and starts the next picking-up operation. It can be assumed that the cycle in which the worker 9 departs the fixed starting point and then returns to the same starting point is one job. The web server unit 55 of the monitoring apparatus 30 can calculate the moved distance of each one of the jobs based on the position information.

The administrator 8 or the like changes the arrangement of parts in some variations. For example, the arrangement of parts is changed between once a week and once a month, and the moved distance of each one of the jobs in that changed arrangement is calculated. Various kinds of jobs may be involved in picking operation. However, when a lot of routine work is involved, even if the worker 9 does various kinds of jobs several times on one day, it is considered that the total moved distance per day varies due to the arrangement of parts. In other words, the arrangement of parts that reduces the total moved distance per day is desired.

As described above, the monitoring apparatus 30 can provide highly-efficient arrangement of parts.

The administrator's PC 50 may display the information in such a manner that a viewer can visually recognize the position information and the cumulative load, as illustrated in FIG. 17.

FIG. 17 is a diagram illustrating a map screen 321 where the relation between a map of the shop floor 7 and the cumulative load is illustrated, according to the present embodiment.

In FIG. 17, a map 322 of the shop floor 7 is displayed in a simplified manner, and the cumulative load of each site is indicated by the height of bar charts 323. The bar charts 323 are illustrated with various colors for each type of posture. As the cumulative load is displayed as above, it becomes easier for the administrator 8 to figure out where a lot of loads are accumulated. Moreover, the type of posture that tends to be taken at a particular site in a large amount can be figured out. Accordingly, for example, the position of parts to be picked up may be changed so as to reduce tough posture (i.e., a posture with heavy load). For example, the parts that are placed at a position where squatting is often required may be moved to a higher position, or the parts that are placed at a position where a bending backward posture is often required may be moved to a lower position.

Note that it is rare for the position information of the worker 9 to perfectly match another position information of the same worker 9. For this reason, it is assumed that, for example, the shop floor 7 is divided into multiple rooms or certain rectangular regions. The web server unit 55 assigns position information to a room or rectangular region, and sums up the total hours of each posture (or the number of times or steps of, for example, walking, going up-and-down the stairs, and carrying operation) for each room or rectangular region.

<Reduction in Errors>

There are some cases in which parts different from as-planned parts are picked up in error by the worker 9. However, it has been difficult for the administrator 8 or the like to identify the reason why such an erroneous picking happened. In the worker data detection system 100 according to the present embodiment, the type of work is identified based on the posture. Accordingly, the relation between the operation and the error can be estimated.

For example, characteristics may be extracted from the operations of a day on which a certain error occurred. Due to this configuration, for example, findings such as “An error occurs when parts are continuously picked up from shelf A four times or more” can be obtained. Such findings as above are obtained when the site “shelf A” and the four-or-more-time continuous pickings are detected in the operation when a plurality of same errors are detected.

In FIG. 12, the monitoring apparatus 30 sends a warning only to the terminal device 10. However, there are some cases in which the monitoring apparatus 30 is to send a warning also to the administrator's PC 50. For example, when the worker 9 collapses, the situation cannot be handled by sending a warning only to the worker 9. When the worker 9 is under control of the administrator 8 in terms of his/her rest time, the worker 9 cannot take a rest at will. Accordingly, it is desired that the monitoring apparatus 30 send a warning to both the terminal device 10 and the administrator's PC 50.

It is considered that the administrator 8 approximately figures out where the worker 9 is. However, there are some cases in which the shop floor 7 is broad or extends through multiple floors, for example, in a distribution center or warehouse. In such cases, it may be difficult for the administrator 8 to find the worker 9 even if the administrator 8 tries to do so. In particular, in cases where the worker 9 has collapsed, he/she cannot be contacted by telephone or the like. In order to avoid such a situation, the monitoring apparatus 30 may send the position information to the administrator's PC 50 as follows.

<Overall Operation>

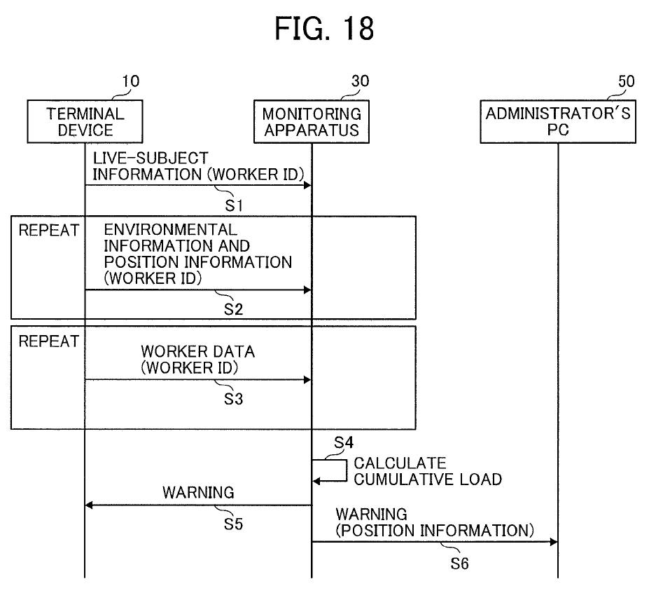

FIG. 18 is another data sequence diagram illustrating overall operation of the worker data detection system 100, according to the present embodiment.

In the description of FIG. 18, the differences from FIG. 12 are described. The processes in the step S1 to S5 are equivalent to those of FIG. 12. S6: The alert unit 56 of the monitoring apparatus 30 sends a warning and the position information of the worker 9 to the administrator's PC 50.

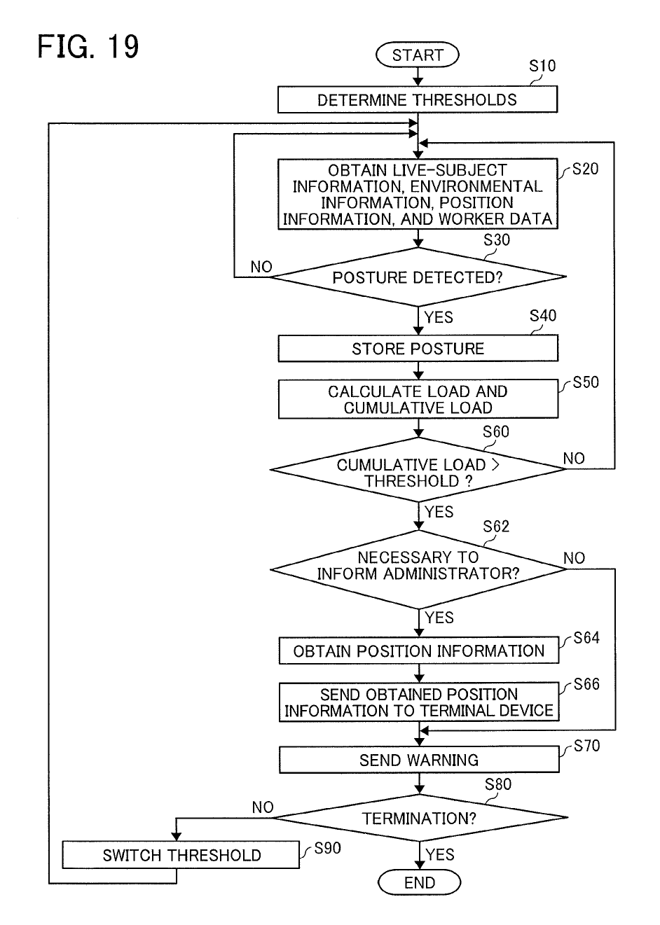

FIG. 19 is another flowchart of procedure for calculating the cumulative load to give warning, by the monitoring apparatus 30, according to the present embodiment.

In the description of FIG. 19, the differences from FIG. 13 are described. The processes in the step S10 to S 60 are equivalent to those of FIG. 13.

When the cumulative load exceeds the first threshold (“YES” in S 60), the alert unit 56 determines whether or not it is necessary to inform the administrator 8 (S62). Whether or not it is necessary to inform the administrator 8 is determined, for example, based on whether the worker 9 has collapsed or not. When the worker 9 has collapsed in the present embodiment, it is assumed that the worker 9 loses consciousness or cannot move even if he/she is conscious. The alert unit 56 detects that, for example, at least one of the position information, the acceleration, the angular speed, the geomagnetism, and the air pressure of the worker 9 does not change at all in order to detect that the worker 9 has collapsed.

For example, whether or not it is necessary to inform the administrator 8 may be determined for each worker 9, or may be determined by the alert unit 56 depending on whether or not there is a request for notification from the terminal device 10 to the administrator's PC 50.

When it is determined to be “YES” in the step S62, the alert unit 56 obtains the position information (S64). The position information may be obtained from the chronological posture information, or the latest position information may be obtained from the terminal device 10.

The alert unit 56 sends the obtained position information to the terminal device 10 (S66). The following processes in FIG. 19 are equivalent to those of FIG. 13.

As described above, the administrator 8 can specify the location of the worker 9 in a reliable manner according to the processes in FIG. 19.

In the above description of the present embodiment, the monitoring apparatus 30 judges a posture and sends a warning. However, the terminal device 10 may perform similar processes on its own.

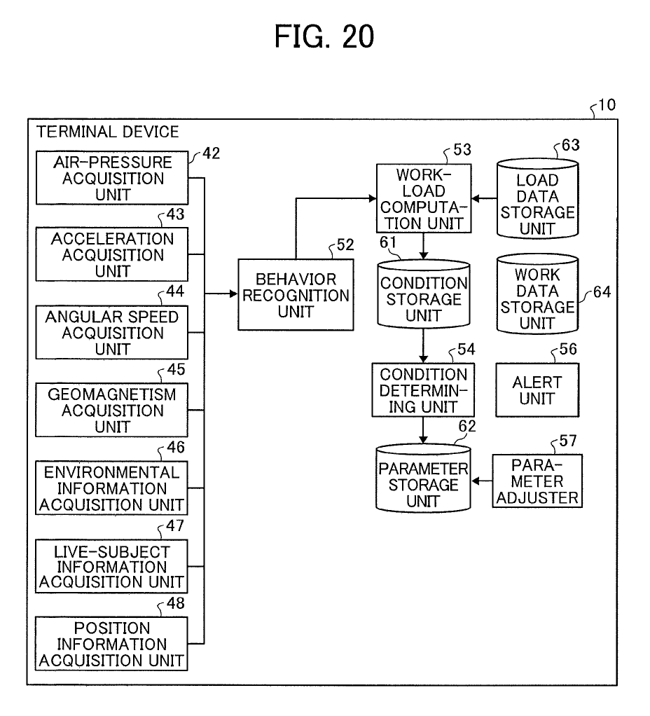

FIG. 20 is a functional block diagram of the terminal device 10 that judges the posture and sends a warning, according to the present embodiment.

As illustrated in FIG. 20, the terminal device 10 has the functions of the monitoring apparatus 30, and the communication unit 41 and the web server unit 55 are not necessary. Due to this configuration as above, the terminal device 10 can judge the posture and send a warning on its own.

As described above, with the worker data detection system 100 according to the present embodiment, the cumulative load that has been accumulated since the worker 9 started working can be managed. When the cumulative load exceeds the threshold, a warning can be done before the worker 9 causes an accident. Accordingly, accidents can be prevented from happening.

<Other Applications>

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

For example, in the present embodiment as described above, the load is calculated based on the worker data such as the acceleration. However, the load may be calculated based on the loudness or volume of the sound. Noise may cause no physical load, but could cause psychological stress. In a similar manner, in view of the fact that smell could have an impact on the load, the load may be calculated based on the air condition or the level of cleanliness in the air.

Note that at least one of the air-pressure acquisition unit 42, the acceleration acquisition unit 43, the angular speed acquisition unit 44, and the geomagnetism acquisition unit 45 is an example of a worker data acquisition unit, and the behavior recognition unit 52 is an example of a load data extraction unit. The work-load computation unit 53 is an example of a load accumulation unit, and the condition determining unit 54 is an example of a determining unit. The alert unit 56 is an example of a warning unit, and the environmental information acquisition unit 46 is an example of an environmental information acquisition unit. The parameter adjuster 57 is an example of a threshold changing unit, and the live-subject information acquisition unit 47 is an example of a tiredness data acquisition unit. The web server unit 55 and the display controller 82 are an example of a display unit.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A worker data detection system comprising:
a memory; and
circuitry configured to
obtain data of at least one worker,
extract load data of the at least one worker from the data of the at least one worker to accumulate the load data of the at least one worker over time in the memory, and
calculate a cumulative load on the at least one worker over time using the load data accumulated in the memory.

2. The worker data detection system according to claim 1, wherein the circuitry detects an alerted state based on the cumulative load and a threshold.

3. The worker data detection system according to claim 2, wherein the circuit outputs a warning when the circuitry detects the alerted state.

4. The worker data detection system according to claim 1, wherein
the circuitry recognizes a posture of the at least one worker based on the data of the at least one worker, and
the circuitry converts the posture into a load with reference to loading unit data in which the posture is associated with a loading unit that indicates a degree of load on the at least one worker caused by the posture, and sums up the load of the posture to calculate the cumulative load.

5. The worker data detection system according to claim 4, wherein the loading unit data includes the loading unit having a negative value associated with the posture.

6. The worker data detection system according to claim 4, wherein
the circuitry obtains environmental information of an environment in which the at least one worker works, and
when the environmental information exceeds an environment threshold, the circuitry calculates the cumulative load upon assigning a weight to the load with a coefficient associated with the environment indicated by the environmental information.

7. The worker data detection system according to claim 4, wherein
the circuitry stores the posture taken by the at least one worker in the memory in association with time, and
the circuitry displays on a display progression of the cumulative load over time and a time zone in which the posture is taken by the at least one worker.

8. The worker data detection system according to claim 4, wherein
the circuitry stores the posture taken by the at least one worker in the memory on the at least one worker by the at least one worker basis,
the at least one worker comprises a plurality of workers, and
the circuitry displays the cumulative load of the plurality of workers on the at least one worker by the at least one worker basis, and displays the posture that makes up the cumulative load.

9. The worker data detection system according to claim 2, wherein
the threshold includes at least a first threshold and a second threshold, the second threshold having a value greater than the first threshold,
the circuitry switches the first threshold to the second threshold when the circuitry determines that the cumulative load has exceeded the first threshold, and
the circuitry compares the cumulative load with the second threshold to detect the alerted state.

10. The worker data detection system according to claim 9, wherein a difference between the first threshold and the second threshold is smaller than the first threshold.

11. The worker data detection system according to claim 9, wherein
the memory stores parameter information in which work experience of the at least one worker, the first threshold, and the second threshold are associated with each other for each of the at least one worker, and
the circuitry updates any one of the first threshold and the second threshold according to the work experience.

12. The worker data detection system according to claim 11, wherein
the parameter information further includes history of accidents in which an accident caused by the at least one worker and a date of the accident are associated with each other for each of the at least one worker, and
the circuitry updates any one of the first threshold and the second threshold according to the history of accidents.

13. The worker data detection system according to claim 11, wherein
the parameter information includes a degree of tolerance to work in association with the at least one worker, and
when the at least one worker is to work on a prescribed operation, the circuitry increases any one of the first threshold and the second threshold based on the degree of tolerance.

14. The worker data detection system according to claim 9, wherein
the circuitry obtains tiredness data of the at least one worker, and
when the circuitry recognizes tiredness of the at least one worker, the circuitry determines an initial value for the cumulative load according to a level of tiredness.

15. A terminal device comprising:
a memory; and
circuitry configured to
obtain data of at least one worker,
extract load data of the at least one worker from the data of the at least one worker to accumulate the load data of the at least one worker over time in the memory, and
calculate a cumulative load on the at least one worker over time using the load data accumulated in the memory.

16. The terminal device according to claim 15, wherein the circuitry detects an alerted state based on the cumulative load and a threshold.

17. A method for detecting worker data, the method comprising:
obtaining data of at least one worker;
extracting load data of the at least one worker from the data of the at least one worker to accumulate the load data of the at least one worker over time; and
calculating a cumulative load on the at least one worker over time using the load data.

18. The method according to claim 17 further comprising detecting an alerted state based on the cumulative load and a threshold.
